(19) United States
(12) Patent Application Publication
(10) Pub. No.: US 2009/0234182 A1
(43) Pub. Date: Sep. 17, 2009

(54) Stress Relief Systems

(76) Inventor: Eric K. Buchholz, Queen Creek, AZ (US)

Correspondence Address: Stoneman Volk Patent Group, 3770 NORTH 7TH STREET, Suite 100, PHOENIX, AZ, 85014, US

(21) Appl. No.: 12/405,071

(22) Filed: Mar. 16, 2009

Related U.S. Application Data
(60) Provisional application No. 61/037,292, filed on Mar. 17, 2008.
(60) Provisional application No. 61/076,572, filed on Jun. 27, 2008.

(51) Int. Cl. A61H 19/00; G06Q 30/00; G06Q 40/00; G06Q 90/00

(52) U.S. Cl. 600/38; 705/26; 705/40

(57) ABSTRACT

A stress relief system comprising segmented sexual aid tools comprising a plurality of interchangeable components, all of which fit together so that a user may customize the shape, girth and length of the sexual aid tool. The system further comprises monetization and internet sales in e-commerce of sexual aid tools utilizing custom orders and rapid fabrication of such interchangeable components.

### CROSS-REFERENCE TO RELATED APPLICATION

The present application is related to and claims priority from prior provisional application Ser. No. 61/037,292, filed Mar. 17, 2008, entitled “STRESS RELIEF SYSTEMS”; and, this application is related to and claims priority from prior provisional application Ser. No. 61/076,572, filed Jun. 27, 2008, entitled “STRESS RELIEF SYSTEMS”, the contents of both of which are incorporated herein by this reference and are not admitted to be prior art with respect to the present invention by the mention in this cross-reference section.

### BACKGROUND

This invention relates to providing a system for improved stress relief in adult humans. More particularly, this invention relates to providing systems and tools to relieve stress using sexual stimulation.

Stress relief may be accomplished in a variety of manners. One such manner is sexual stimulation and climax. It would be useful to improve current sexual aid tool systems to accommodate a user-preferred preference as to size, girth, length, etc. For example, a need exists in the market place for a sexual aid that is highly customizable to an individual user's wants or needs.

### OBJECTS AND FEATURES OF THE INVENTION

A primary object and feature of the present invention is to provide a system overcoming the above mentioned problems.

It is a further primary object and feature of the present invention to provide such a system comprising monetization methods for internet sales in ecommerce of interchangeable component sexual aids. Another object and feature of the present invention is to provide a sexual aid with at least three interchangeable segments that may be user-selected for individual stress relief.

Another object and feature of the present invention is to provide a sexual aid system to provide sexual aid tools that are customizable to user's preferences.

Another object and feature of the present invention is to provide a sexual aid system comprising a customizing kit.

Another object and feature of the present invention is to provide a sexual aid system with machined parts.

Another object and feature of the present invention is to provide a sexual aid system with shapes that are not limited to a single axis.

Another object and feature of the present invention is to provide a sexual aid system comprising at least one sexual aid tool that comprises a plurality of segmented portions, so that the sexual aid tool may be taken apart and put back together in customizable (user chosen) segments.

Another object and feature of the present invention is to provide a sexual aid system wherein users may customize the shape and size of the sexual aid tool, depending on such user's preference, using components of the sexual aid system.

Another object and feature of the present invention is to provide a sexual aid system wherein the plurality of segmented tool portions comprises a plurality of interchangeable segmented portions.

It is a further object and feature of the present invention to provide such a system comprising variety of different segments that may differ in size, shape, color, weight and capabilities that may also be user-selected.

It is a further object and feature of the present invention to provide such a system comprising monetization using real and virtual world applications.

It is a further object and feature of the present invention to provide such a system comprising monetization in retail, wholesale and other brick-and-mortar goods and/or services establishments.

A further primary object and feature of the present invention is to provide such a system that is efficient, inexpensive and handy. Other objects and features of this invention will become apparent with reference to the following descriptions.

### SUMMARY OF THE INVENTION

In accordance with a preferred embodiment hereof, this invention provides a sexual aid system comprising: at least three segments, each segment of such at least three segments structured and arranged to couple to all other such segments; wherein any at least two of such at least three segments, when assembled, comprise a sexual-aid tool; and wherein each such segment of such at least three segments comprises at least one first end comprising at least one first coupler; and/or at least one second end comprising at least one second coupler; and wherein such at least one first coupler element is attachable to such at least one second coupler element.

Moreover, it provides such a system wherein: any such at least three segments, when assembled, comprise at least one sexual-aid tool; wherein such sexual-aid tool comprises a single longitudinal internal chamber; wherein such single longitudinal internal chamber comprises at least one central axis; and wherein portions of such at least one central axis are located within each one of such at least three intercouplable segments. Additionally, it provides such a system wherein such single longitudinal internal chamber is structured and arranged to hold at least one vibratory element.

Also, it provides such a system wherein such at least one sexual-aid tool is structured and arranged to be length customized by a user. In addition, it provides such a system wherein such at least three segments comprise: at least one first end segment comprising at least one first coupler; at least one second end segment comprising at least one second coupler; and at least one middle segment comprising at least at least one first coupler and at least one second coupler; wherein such at least one first coupler is attachable to such at least one second coupler. And, it provides such a system wherein such at least one sexual-aid tool is structured and arranged to be length adjustable, to any user-selected length, using a plurality of such at least one middle segments. Further, it provides such a system wherein each such at least one first coupler and such at least one second coupler are structured and arranged to assist connecting any of at least one first, at least one second, and at least one third segments of such at least three segments.

Even further, it provides such a system wherein such at least one first coupler and such at least one second coupler comprise threaded couplers. Moreover, it provides such a system further comprising: at least one sealing assembly structured and arranged to form at least one substantially fluid-resistant seal between intercoupled pairs of such at least three segments; wherein such at least one sealing assembly assist in retaining fluids within such single longitudinal internal chamber. Additionally, it provides such a system wherein such at least one sealing assembly comprises a plurality of circumferential sealing members with each one structured and arranged to seal such intercoupled pairs of such at least three segments. Also, it provides such a system wherein each one of such plurality of circumferential sealing members comprises at least one O-ring seal.

In addition, it provides such a system wherein at least one of such at least three segments comprises at least one millable plastic material. And, it provides such a system wherein such at least one millable plastic material substantially comprises acrylic. Further, it provides such a system wherein at least one of such at least three segments comprises at least one metal.

Even further, it provides such a system wherein such at least one sexual-aid tool substantially comprises at least one metal. Moreover, it provides such a system wherein such at least one metal substantially comprises aluminum. Additionally, it provides such a system wherein such aluminum comprises at least one anodized finish.

Also, it provides such a system wherein at least one of such at least three segments comprises at least one axially symmetric outer shape. In addition, it provides such a system wherein at least one of such at least three segments comprises at least one axially asymmetric outer shape. And, it provides such a system wherein such at least one sexual-aid tool comprises at least one generally phallic shape.

In accordance with another preferred embodiment hereof, this invention provides a sexual aid kit system for producing user-assembled segmented sexual aid tools, such method comprising: at least one starter sexual aid kit comprising at least three intercouplable segments, at least one set of instructions for assembling such at least three intercouplable segments to form at least one sexual-aid tool, and at least one package structured and arranged to hold such at least three intercouplable segments; wherein such assembled sexual-aid tool comprises a single longitudinal internal chamber; wherein such single longitudinal internal chamber comprises at least one central axis; and wherein portions of such at least one central axis are located within each one of such at least three intercouplable segments.

Further, it provides such a sexual aid kit system further comprising: at least one accessory sexual aid kit; wherein such at least one accessory sexual aid kit comprises at least one member of the group consisting essentially of at least one additional intercouplable segment intercouplable with at least one of such at least three intercouplable segments of such at least one starter sexual aid kit, at least one sexual aid element insertable within such single longitudinal internal chamber at least one storage pouch structured and arranged to store such sexual-aid tool, at least one repair item structured and arranged to assist user repair of such sexual-aid tool, at least one set of instructions, and at least one package structured and arranged to hold the contents of such at least one accessory sexual aid kit. Even further, it provides such a sexual aid kit system further comprising at least one additional individually packaged intercouplable segment intercouplable with at least one of such at least three intercouplable segments of such at least one starter sexual aid kit. Further, it provides such a sexual aid kit system further comprising: at least one substantially solid single-piece sexual-aid tool.

In accordance with another preferred embodiment hereof, this invention provides a method, relating to the production of segmented sexual aid tools comprising a plurality of intercouplable segments, such method comprising the steps of: producing at least one computer-aided design for at least one segmented sexual aid tool comprising a plurality of intercouplable segments; deriving from such at least one computer-aided design, software control instructions for at least one multi-axis computer numerical controlled machine tool; producing at least one first end segment of such segmented sexual aid tool using at least one multi-axis computer numerical controlled machine tool controlled by such software control instructions; producing at least one second end segment of such segmented sexual aid tool using such at least one multi-axis computer numerical controlled machine tool controlled by such software control instructions; and producing at least one intermediate segment of such segmented sexual aid tool using such at least one multi-axis computer numerical controlled machine tool controlled by such software control instructions; wherein such at least one first end segment comprises at least one first coupler; wherein such at least one second end segment comprises at least at least one second coupler; wherein such at least one intermediate segment comprises both at least one first coupler and at least one second coupler; and wherein such at least one first coupler is intercouplable with such at least one second coupler. Moreover, it provides such a method further comprising the step of providing such at least one substantially solid material in the form of at least one aluminum billet. Additionally, it provides such a method further comprising the step of polishing at least one of such at least one first end segment, such at least one second end segment, and such at least one intermediate segment.

Also, it provides such a method further comprising the step of applying at least one anodized finish to at least one of such at least one first end segment, such at least one second end segment, and such at least one intermediate segment.

In accordance with another preferred embodiment hereof, this invention provides a method, relating to marketing of segmented sexual aid tools comprising at least one assembly of user-interchangeable sexual-aid-tool parts, such method comprising the steps of: displaying in at least one first display, such segmented sexual aid tools in a substantially assembled condition; displaying in at least one second display, a plurality of such user-interchangeable sexual-aid-tool parts; and displaying in at least one third display, adjoining such at least one first display and such at least one second display, information relating to possible user-customization of such segmented sexual aid tools using such intercouplable sexual aid tool parts.

In addition, it provides such a method further comprising the steps of: offering for sale such segmented sexual aid tools and such plurality of user-interchangeable sexual-aid-tool parts; wherein such step of offering for sale comprises the step of displaying within at least one of such at least one first display, such at least one second display, and such at least one third display, product ordering information for assisting selection and ordering of such segmented sexual aid tools and such plurality of user-interchangeable sexual-aid-tool parts. And, it provides such a method wherein such product ordering information comprises at least one telephone number of at least one segmented sexual aid tools product fulfillment site. Further, it provides such a method wherein such product ordering information comprises at least one Internet website address associated with at least one segmented sexual aid tools product fulfillment website. Even further, it provides such a method wherein such product ordering information comprises at least one order form usable within at least one segmented sexual aid tools retail site.

In accordance with another preferred embodiment hereof, this invention provides a method, relating to marketing of segmented sexual aid tools comprising at least one assembly of user-interchangeable sexual-aid-tool parts, such method comprising the steps of: providing to at least one customer, at least one purchasing-interface for the purchasing of such user-interchangeable sexual-aid-tool parts; wherein such at least one purchasing-interface comprises; at least one customer-selection interface structured and arranged to enable selecting of at least one custom combination of such user-interchangeable sexual-aid-tool parts usable to assemble at least one segmented sexual aid tool, at least one customer-order interface structured and arranged assist in generating at least one custom order of such user-interchangeable sexual-aid-tool parts, and at least one customer-payment interface structured and arranged assist in the acceptance of payment at least one custom order of such user-interchangeable sexual-aid-tool parts; providing for the manufacture of such at least one custom order of such user-interchangeable sexual-aid-tool parts on receipt of such at least one custom order and such payment; providing for shipping such at least one custom order of such user-interchangeable sexual-aid-tool parts to such at least one customer. Even further, it provides such a method further comprising the step of establishing at least one Internet website server structured and arranged host at least one website comprising such at least one purchasing-interface. Even further, it provides such a method further comprising the step of establishing at least one retail distribution site comprising such at least one purchasing-interface.

In accordance with another preferred embodiment hereof, this invention provides a sexual aid system comprising: at least three segments, each segment of such at least three segments structured and arranged to couple to all other such segments; wherein any at least two of such at least three segments, when assembled, comprise a sexual-aid tool; and wherein each such segment of such at least three segments comprises at least one first end comprising at least one first coupler element; and/or at least one second end comprising at least one second coupler element; and wherein such at least one first coupler element is attachable to such at least one second coupler element.

In accordance with another preferred embodiment hereof, this invention provides each and every novel feature, element, combination, step and/or method disclosed or suggested by this patent application.

### BRIEF DESCRIPTION OF THE DRAWINGS

FIG. 1 shows a diagrammatic view, illustrating a plurality of segmented portions for a sexual aid tool of the stress relief system, according to a preferred embodiment of the present invention.

FIG. 2 shows an exploded perspective view, illustrating a sexual aid tool of the stress relief system, according to the preferred embodiment of FIG. 1.

FIG. 3 shows an exploded side view, illustrating the sexual aid tool according to the preferred embodiment of FIG. 2.

FIG. 4 shows the sectional view 4-4 of FIG. 3 according to the preferred embodiment of FIG. 2.

FIG. 5 shows a sectional view, illustrating a first end portion of the sexual aid tool comprising a female coupling element, according to the preferred embodiment of FIG. 4.

FIG. 6 shows a sectional view, illustrating a first end portion of the sexual aid tool comprising a male coupling element, according to another preferred embodiment of the present invention.

FIG. 7 shows a sectional view, illustrating a middle portion of the sexual aid tool comprising dual female coupling elements, according to another preferred embodiment of the present invention.

FIG. 8 shows a sectional view, illustrating a middle portion of the sexual aid tool comprising dual male coupling elements, according to another preferred embodiment of the present invention.

FIG. 9 shows a sectional view illustrating a middle portion of the sexual aid tool comprising a male end-coupling element and a female end-coupling element according to another preferred embodiment of the present invention.

FIG. 10 shows a sectional view, illustrating a middle portion of the sexual aid tool comprising dual male coupling elements, according to another preferred embodiment of the present invention.

FIG. 11 shows a sectional view, illustrating a middle portion of the sexual aid tool comprising dual female coupling elements, according to another preferred embodiment of the present invention.

FIG. 12 shows a sectional view, illustrating a second end portion of the sexual aid tool comprising a male coupling element, according to another preferred embodiment of the present invention.

FIG. 13 shows a sectional view, illustrating a second end portion of the sexual aid tool comprising a female coupling element, according to another preferred embodiment of the present invention.

FIG. 14 shows a side view, of a single-axis segmented sexual aid tool of the stress relief system, according to the preferred embodiment of FIG. 1.

FIG. 15 shows a side view, of a multiple-axis segmented sexual aid tool of the stress relief system, according to another preferred embodiment of the present invention.

FIG. 16 shows a side view, of another multiple-axis segmented sexual aid tool of the stress relief system, according to another preferred embodiment of the present invention.

FIG. 17 shows a side view, of another multiple-axis segmented sexual aid tool of the stress relief system, according to another preferred embodiment of the present invention.

FIG. 18 shows a side view, partially in section, of a preferred pouch for the sexual aid tool of the stress relief system, according to a preferred embodiment of the present invention.

FIG. 19 shows a schematic diagram, illustrating preferred items making up a preferred kit, according to another preferred embodiment of the present invention.

FIG. 20 shows a schematic diagram, illustrating preferred individual components and accessory kits usable to augment the starter kit of FIG. 19, according to another preferred embodiment of the present invention.

FIG. 21 shows a schematic flow diagram, illustrating a preferred production method, according to the present invention.

FIG. 22 shows an overall schematic diagram, illustrating a preferred sexual-aid business-architecture, according to a preferred monetizing method of the present invention.

FIG. 23 shows a schematic diagram, illustrating a preferred retail purchase transaction and subsequent direct purchase transaction by the end consumer, according to the preferred monetizing method of FIG. 22.

FIG. 24 shows a processing flowchart according to a preferred method for stress relief tool system customization involving user input data and user-provided specifications, according to the preferred monetization method of FIG. 22.

FIG. 25 shows a schematic illustration, of a user input data screen of a website, according to the preferred monetization method of FIG. 22.

FIG. 26 shows a processing flowchart, illustrating the preferred steps for a user customization involving the uploading of customer input data, according to the preferred monetization method of FIG. 22.

FIG. 27 shows a schematic block diagram of a typical processor configuration for an implementation of the preferred monetization method of FIG. 22.

FIG. 28 shows an exploded perspective view, illustrating another sexual aid tool of the stress relief system, according to another preferred embodiment of the present invention.

FIG. 29 shows a side view, illustrating an assembled sexual aid tool of the stress relief system, according to the preferred embodiment of FIG. 28.

FIG. 30 shows a perspective view, illustrating another assembled sexual aid tool of the stress relief system, according to another preferred embodiment of the present invention.

FIG. 31 shows a sectional view illustrating a fixed vibrator insert for a section of the sexual aid tool of the stress relief system, according to another preferred embodiment of the present invention.

FIG. 32 shows a sectional view illustrating an insertable vibrator insert for a section of the sexual aid tool of the stress relief system, according to another preferred embodiment of the present invention.

### DETAILED DESCRIPTION OF THE BEST MODES AND PREFERRED EMBODIMENTS OF THE INVENTION

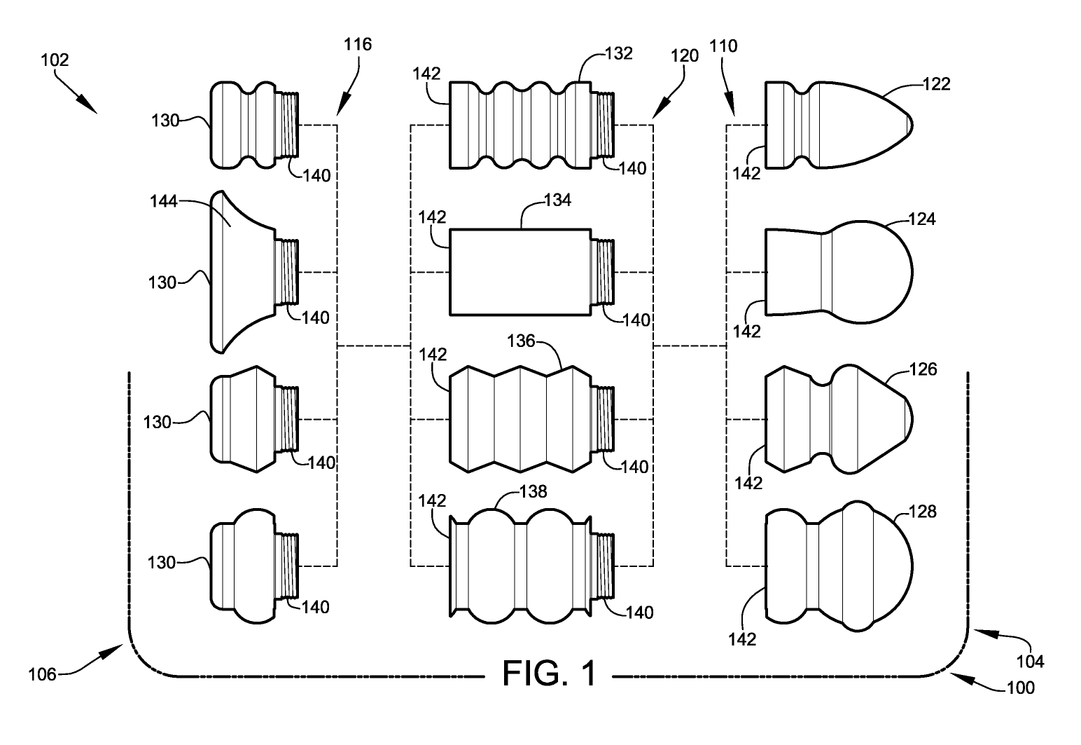

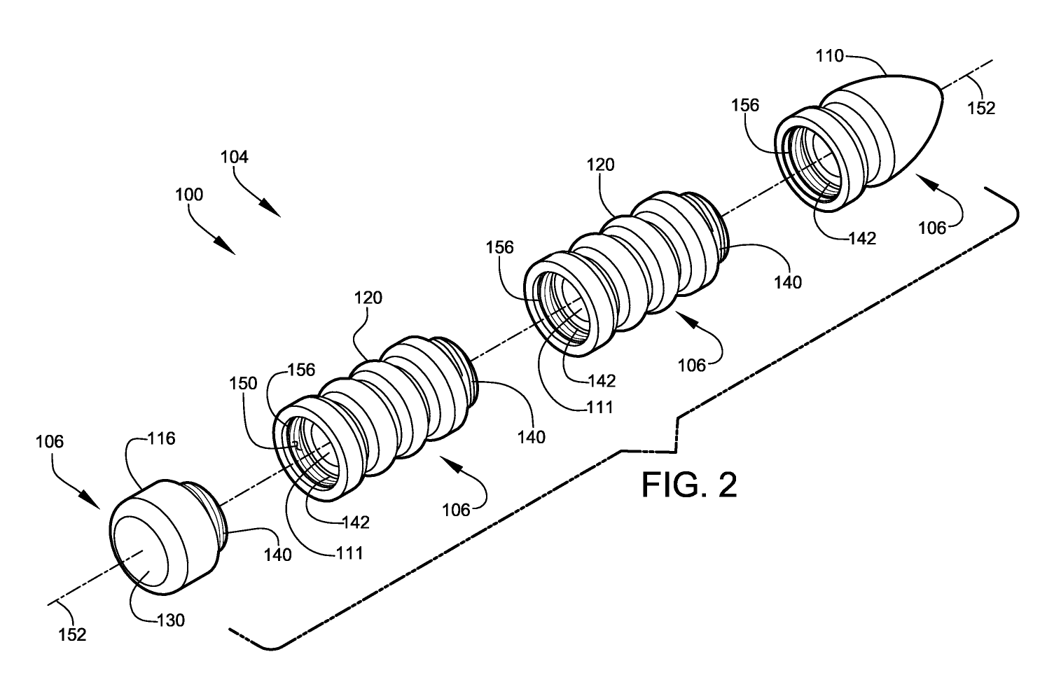

FIG. 1 shows a diagrammatic view illustrating a plurality of segmented portions 106 of a preferably user-assembled, segmented, sexual aid tool 104 of the stress relief system 100 according to a preferred embodiment of the present invention. FIG. 2 shows an exploded perspective view, illustrating a selection of segmented portions 106 aligned to allow for the assembly of a single, segmented, sexual aid tool 104 of the stress relief system 100, according to the preferred embodiment of FIG. 1.

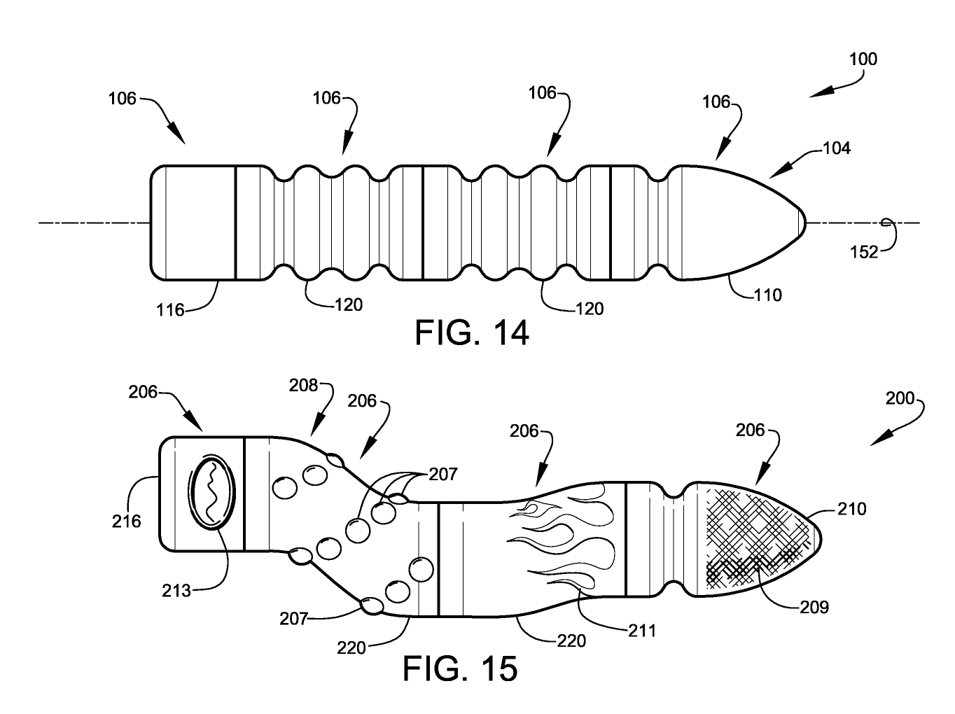

The stress relief system 100 is preferably comprised of a plurality of segmented portions 106 that can preferably be attached to each other to produce a segmented, sexual aid tool 104 (see also FIG. 14). Segmented sexual aid tool 104 is preferably capable of being assembled and disassembled so that a user may change the shape or size of the tool by selecting from available segments. Such selection is preferably user-customizable simply by reattaching the segmented portions 106 in a different orientation or by the addition or deletion of additional segmented portions 106 by the user. For example, choosing different segmented portions 106 may increase or decrease the width, increase or decrease the girth, add a segment with a different exterior surface, add a unique protrusion, etc.

The plurality of segmented portions 106 preferably comprises at least one first-end portion 110, at least one second-end portion 116 and at least one middle portion 120, as shown. First-end portion 110 is preferably selectable from a plurality of first-end portions 110, as shown. Second-end portion 116 is preferably selectable from a plurality of second-end portions 116, as shown. Middle portion 120 is preferably selectable from a plurality of middle portions 120, as shown. Upon reading this specification, those with ordinary skill in the art will now appreciate that, under appropriate circumstances, considering such issues as design preference, user preferences, marketing preferences, cost, structural requirements, available materials, technological advances, etc., other segmented portion arrangements such as, for example, matching-end portion segments, mirrored-end portion segments, more than two end portions (such as a cross-configuration), multiple middle sections, etc., may suffice.

In the preferred embodiment of FIG. 1, first-end portions 110 preferably comprise multiple shapes, such as conical shape 122, bulbous shape 124, mushroom shape 126, and helmet shape 128, as shown. While the shapes of first-end portions 110 may also be utilized as second-end portion shapes, second-end portions 116 preferably comprise at least one portion having at least one base element, preferably a flat bottom 130 to allow the segmented sexual aid tool 104 to be placed in an upright position when placed on a flat surface.

First end portions 110 are preferably about two and one-half inches in length, not including external coupling elements, and preferably have a girth preferably between about one inch and about two inches in diameter. Upon reading this specification, those with ordinary skill in the art will now appreciate that, under appropriate circumstances, considering such issues as design preference, user preferences, marketing preferences, cost, structural requirements, available materials, technological advances, etc., other dimensions for girth such as, for example, about one inch to about four inches, larger or smaller dimensions, serpentine dimensions, varying diameters, etc., may suffice.

Preferably, second end portions 116 comprise at least one set of shapes that are aesthetically pleasing and functional (i.e. as a sexual aid, including comprising gripping portions) when matched to at least one of such first end portions 110, as shown. Second end portions 116 are preferably about two and one-half inches in length not including external coupling elements and have a girth at least about an inch in diameter and preferably between about one inch and about two inches in diameter. Upon reading this specification, those with ordinary skill in the art will now appreciate that, under appropriate circumstances, considering such issues as design preference, user preferences, marketing preferences, cost, structural requirements, available materials, technological advances, etc., other dimensions for girth such as, for example, about one inch to about four inches, larger or smaller dimensions, serpentine dimensions, varying diameters, etc., may suffice. The flat bottom 130 preferably has the same diameter as the rest of the second end portion 116 or larger. As illustrated in FIG. 1, the flat bottom 130 may be much larger, in order to provide a stable base as well as a hand-grippable portion 144 for a user.

Preferably, middle portions 120 also comprise at least one set of shapes that are aesthetically pleasing and functional when matched to at least one of such first-end portions 110, as shown. For example, middle portion 132 is preferably ribbed, middle portion 134 is preferably smooth, middle portion 136 is preferably accordion-shaped and middle portion 138 is preferably bulging, as shown. Upon reading this specification, those with ordinary skill in the art will now appreciate that, under appropriate circumstances, considering such issues as design preference, user preferences, marketing preferences, cost, structural requirements, available materials, technological advances, etc., other shaped arrangements such as, for example, serpentine, ridged, rounded, shaped combinations, etc., may suffice. Middle portion 120 preferably is about two and one-half to about four inches in length; however, the middle portion 120 is substantially customizable as it is the portion easily offered in a variety of interchangeable shapes and sizes to effect the customization of the segmented sexual aid tool 104.

Barring specific specialized embodiments, any segmented portion 106 is preferably intercouplable with any other segmented portion 106 within the system, preferably by means of a set of compatible couplers. This highly-preferred feature provides essentially universal interchangeability of parts to enable exceptional customization potential. Preferably, each respective first-end portion 110, second-end portion 116, and middle portion 120 comprises at least one coupling element, preferably male coupler/female coupler elements, highly preferably comprising male threaded coupler elements 140 and female threaded coupler elements 142, as shown. By manufacturing a plurality of segmented portions 106 with both male threaded coupler elements 140 and female threaded coupler elements 142, the stress relief system 100 provides for a large number of different combinations of segmented portions 106 that may be combined to form any one segmented sexual aid tool 104, as shown. Upon reading this specification, those with ordinary skill in the art will now appreciate that, under appropriate circumstances, considering such issues as design preference, user preferences, marketing preferences, cost, structural requirements, available materials, technological advances, etc., other coupler arrangements such as, for example, bayonet coupling, magnetic coupling, press fit coupling, flexible couplings, living hinge couplings, double-male couplers, double-female couplers, cam-lock fittings, compression couplers, etc., may suffice. Further, upon reading this specification, those with ordinary skill in the art will now appreciate that, under appropriate circumstances, considering such issues as design preference, user preferences, marketing preferences, cost, structural requirements, available materials, technological advances, etc., other permanent coupling arrangements for user-customized selection and then permanent coupling of such customized selection such as, for example, permanent adhesive, permanent snap-lock, etc., may suffice.

When preferably assembled into a segmented sexual aid tool 104 as generally shown in FIG. 2 (and best illustrated in FIG. 4), each respective segmented portion 106 preferably comprises a bore portion, preferably a through-bore 111 in the middle portions 120, which assists the formation of a longitudinal internal chamber 150, as shown. Highly preferably, when assembled, the segmented sexual aid tool 104 comprises a single longitudinal internal chamber, preferably along at least one central axis 152, as shown. Upon reading this specification, those with ordinary skill in the art will now appreciate that, under appropriate circumstances, considering such issues as design preference, user preferences, marketing preferences, cost, structural requirements, available materials, technological advances, etc., other internal chamber arrangements such as, for example, multiple hollows, alternating hollows and solid portions, etc., may suffice.

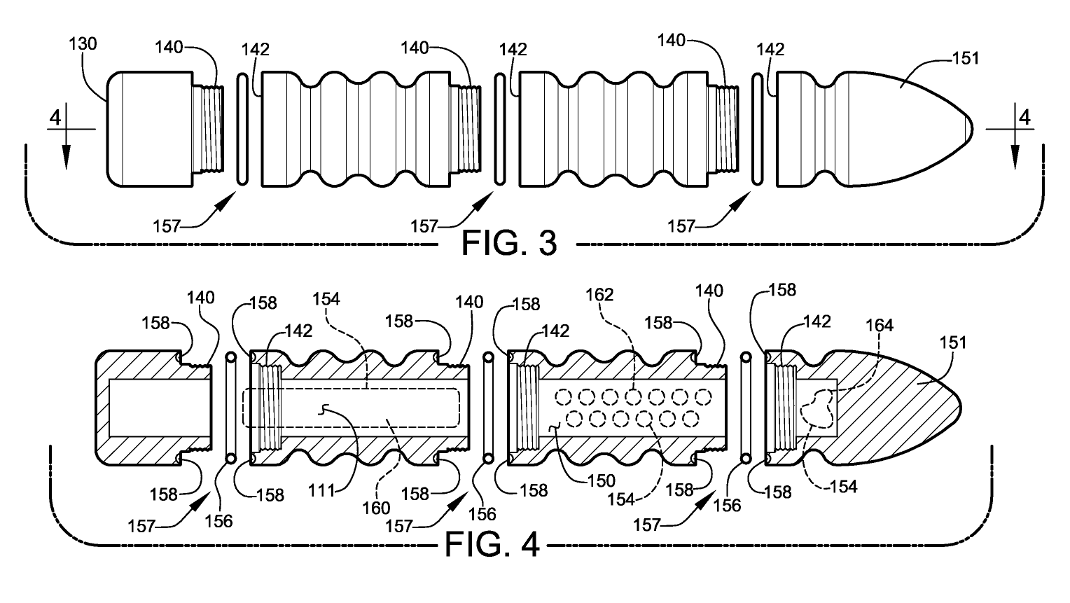

FIG. 3 shows a side view, illustrating the segmented sexual aid tool 104 according to the preferred embodiment of FIG. 2. FIG. 4 shows the sectional view 4-4 of FIG. 3 according to the preferred embodiment of FIG. 2. Preferably, the longitudinal internal chamber 150 in combination with male threaded coupler elements 140 and female threaded coupler elements 142 provides an arrangement wherein other sexual aid elements 154 may be placed into the longitudinal internal chamber 150. Preferably, for example, longitudinal internal chamber 150 is sized to accept such other sexual aid elements 154 that comprise: at least a slim-line vibrator 160; ball-bearings 162; and lubricant 164. A preferred slim-line vibrator 160 comprises at least one “Slim Line Vibrator” (as manufactured by California Exotics, for example). Upon reading this specification, those with ordinary skill in the art will now appreciate that, under appropriate circumstances, considering such issues as manufacturing preference, cost, structural requirements, available materials, technological advances, etc., other vibratory devices may suffice.

Preferably, longitudinal internal chamber 150 is sized from about ½ inch in diameter to about 1 inch in diameter, highly preferably, about 75%-90% of the overall diameter of the sexual aid tool is removable for the longitudinal internal chamber 150, primarily to keep the segmented sexual aid tool 104 lighter and allow for maximum insertion of such additional accessory features as described herein. The longitudinal internal chamber 150 preferably must not be so large as to render the wall thickness of the sexual aid device so thin as to not be structurally sound. Preferably, at least one eighth inch in wall thickness is desired depending on machinable material chosen, such as aluminum, for example. Upon reading this specification, those with ordinary skill in the art will now appreciate that, under appropriate circumstances, considering such issues as design preference, user preferences, marketing preferences, cost, structural requirements, available materials, technological advances, etc., other longitudinal internal chamber dimensions and other wall thickness dimensions such as, for example, larger or smaller, etc., may suffice.

As described above, longitudinal internal chamber 150 preferably is a through-bore portion that provides for a reduction in material weight and also provides for a user-preferred addition of elements or devices to customize such segmented sexual aid tool 104. Preferably, a user may purchase or add such elements or devices, such as, for example, cold or heated water, cold or heated elements, alternate vibratory elements, beads, lubricants, scented liquids, etc. Upon reading this specification, those with ordinary skill in the art will now appreciate that, under appropriate circumstances, considering such issues as manufacturing preference, cost, structural requirements, available materials, technological advances, etc., other elements or devices may suffice.

Preferably, segmented portions 106 are available with a sealing assembly 157 structured and arranged to form at least one substantially fluid-resistant seal between intercoupled pairs of segmented portions 106. Sealing assembly 157 preferably utilizes circumferential sealing members, preferably flexible O-rings 156, preferably placed in O-ring grooves 158 machined within the contact faces of segmented portions 106 surrounding the threaded coupling elements. Preferably, the sealing assembly 157 seals segmented sexual aid tool 104 so that fluids, such as lubricants, do not either enter the segmented sexual aid tool 104, or leak from the segmented sexual aid tool 104, when assembled (at least embodying herein at least one sealing assembly structured and arranged to form at least one substantially fluid-resistant seal between intercoupled pairs of such at least three intercouplable segments; wherein such at least one sealing assembly assists in retaining fluids within such single longitudinal internal chamber; wherein such at least one sealing assembly comprises a plurality of circumferential sealing members, and wherein each one of such plurality of circumferential sealing members comprises at least one O-ring seal). Upon reading this specification, those with ordinary skill in the art will now appreciate that, under appropriate circumstances, considering such issues as manufacturing preference, cost, structural requirements, available materials, technological advances, etc., other sealing means such as, gaskets, threading tolerances, thread tape, etc., may suffice.

Preferably, segmented sexual aid tool 104 is made of a material that readily accepts engraving, embossing, and machine shaping. Segmented sexual aid tool 104 is preferably made of corrosion-resistant material to prevent degradation of the material from repeated use. Segmented sexual aid tool 104 is preferably made of material can be cleaned with little effort. In general, materials that might result in toxicity to the user are preferably avoided.

Segmented sexual aid tool 104 is most preferably manufactured using at least one machinable material 151. Preferably, machinable material 151 comprises metal, highly preferably anodized aluminum. Segmented sexual aid tool 104 preferably is manufactured by machining, preferably using a lathe, more preferably utilizing at least a 3-axis computer numerically controlled (CNC) lathe, and highly preferably, at least a 5-axis CNC lathe.

Alternately preferably, the segmented sexual aid tool 104 is made of a material that is both millable and lightweight, preferably a millable plastic material. A highly preferred plastic material comprises acrylic. Upon reading this specification, those with ordinary skill in the art will now appreciate that, under appropriate circumstances, considering such issues as design preference, user preferences, marketing preferences, cost, structural requirements, available materials, technological advances, etc., other materials and manufacturing methods such as, for example, molded rubbers, molded plastics, vacuum-formed materials, etc., may suffice. Furthermore, upon reading this specification, those with ordinary skill in the art will now appreciate that, under appropriate circumstances, considering such issues as manufacturing preference, cost, structural requirements, available materials, technological advances, etc., other machinable materials such as, other metals (including stainless steel, titanium, nickel, and platinum), wood, glass, carbon-fiber, etc., may suffice.

As part of the preferred machining processes, segmented sexual aid tool 104 is provided with a smooth outer finish, more preferably a smooth polished finish. Preferably, segmented sexual aid tool 104 is made of a material, as described above, which can be anodized, coated and embossed, engraved, or otherwise customized. Such customization will be further discussed herein as a method of offering customization of such segmented sexual aid tool 104. In addition, segmented sexual aid tool 104 preferably can be surface-treated with other durable finishes available in a plurality of colors.

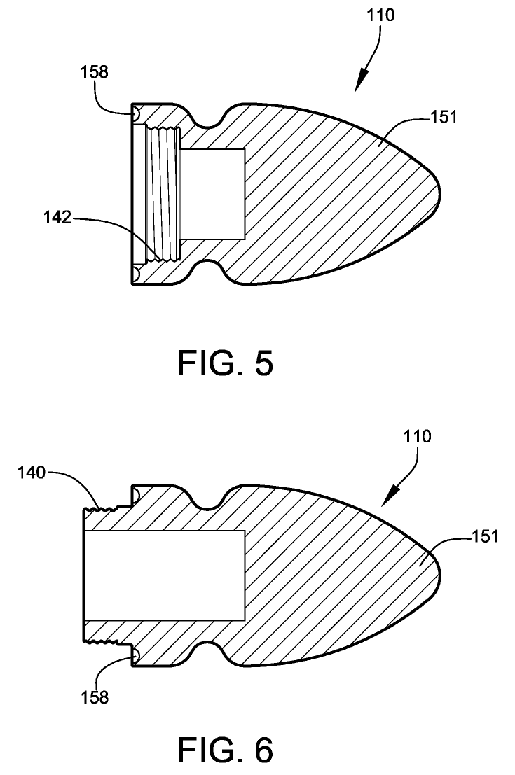

FIG. 5 shows a sectional view illustrating a first-end portion 110 of the segmented sexual aid tool 104 comprising a female threaded coupler element 142 according to the preferred embodiment of FIG. 4. FIG. 6 shows a sectional view illustrating a first-end portion 110 of the segmented sexual aid tool 104 comprising a male threaded coupler element 140 according to another preferred embodiment of the present invention. FIG. 5 and FIG. 6 illustrate alternate preferences as to coupler elements to teach that either a male threaded coupler element 140 or female threaded coupler element 142 can be placed onto a first end portion 110 so that the first-end portion 110 may be used on either end of a middle portion 120, as shown.

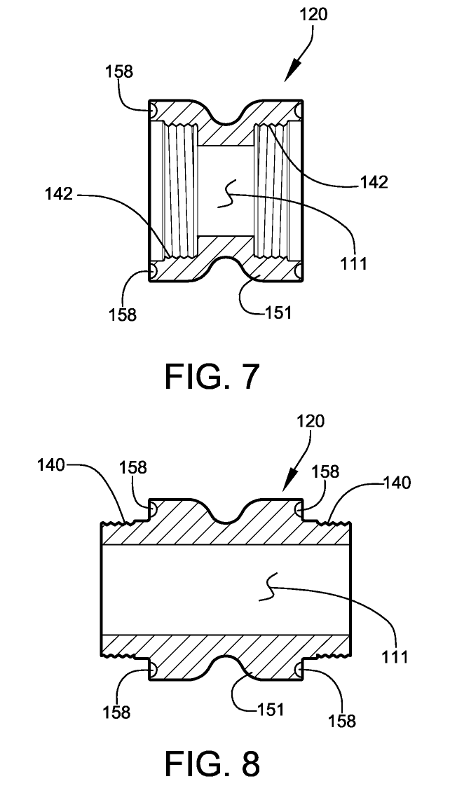

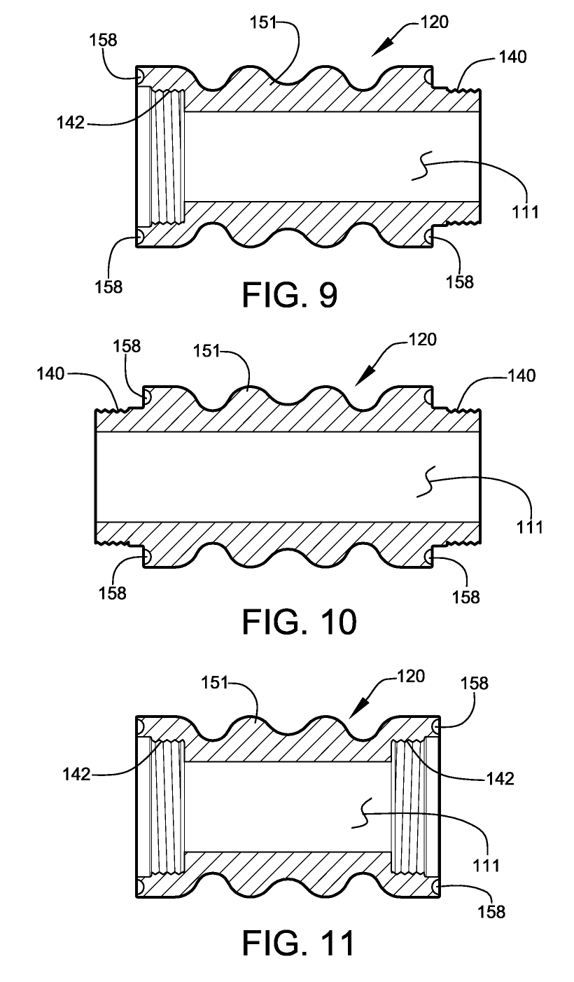

FIG. 7 shows a sectional view illustrating a middle portion 120 of the segmented sexual aid tool 104 comprising dual female threaded coupler elements 142 according to another preferred embodiment of the present invention. FIG. 8 shows a sectional view illustrating a middle portion 120 of the segmented sexual aid tool 104 comprising dual, male threaded coupler elements 140 according to another preferred embodiment of the present invention. FIG. 9 shows a sectional view illustrating a middle portion 120 of the segmented sexual aid tool 104 comprising male threaded coupler element 140 and female threaded coupler element 142 according to another preferred embodiment of the present invention. FIG. 10 shows a sectional view illustrating a middle portion 120 of the segmented sexual aid tool 104 comprising dual male threaded coupler element 140 according to another preferred embodiment of the present invention. FIG. 11 shows a sectional view illustrating a middle portion 120 of the segmented sexual aid tool 104 comprising dual female threaded coupler elements 142 according to another preferred embodiment of the present invention. FIG. 7, FIG. 8, FIG. 9, FIG. 10 and FIG. 11 illustrate alternate preferences as to coupler elements to teach that a male threaded coupler element 140, female threaded coupler element 142 and dual female or dual male coupler elements can be placed onto middle portion 120 so that either end of a middle portion 120 can be coupled with either first end portion 110 or second end portion 116 or other middle portions 120, as shown.

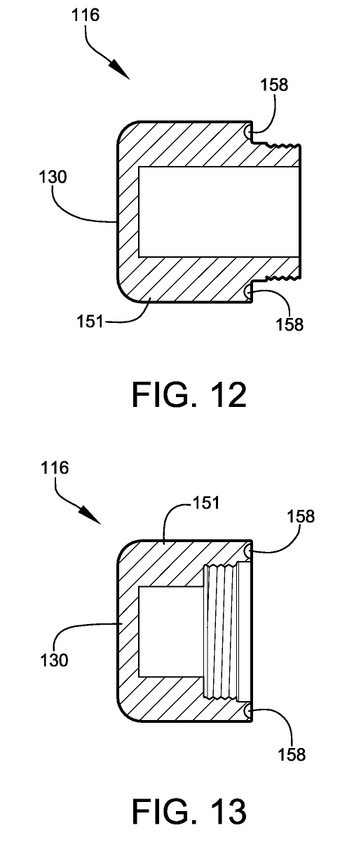

FIG. 12 shows a sectional view illustrating a second end portion 116 of the segmented sexual aid tool 104 comprising male threaded coupler element 140 according to another preferred embodiment of the present invention. FIG. 13 shows a sectional view illustrating a second end portion 116 of the segmented sexual aid tool 104 comprising female threaded coupler element 142 according to another preferred embodiment of the present invention. FIG. 12 and FIG. 13 illustrate alternate preferences as to coupler elements to teach that either a male threaded coupler element 140 or female threaded coupler element 142 can be placed onto a second end portion 116 so that the second end portion 116 may be used on either end of a middle portion 120, as shown. Upon reading this specification, those with ordinary skill in the art will now appreciate that, under appropriate circumstances, considering such issues as design preference, user preferences, marketing preferences, cost, structural requirements, available materials, technological advances, coupler advances, etc., other coupling arrangements such as, for example, separate coupling elements (double male ends or double female ends that connect to each segment, internal sleeve coupling elements, etc., may suffice.

FIG. 14 shows a side view of a single-axis segmented sexual aid tool 104 according to the preferred embodiment of FIG. 1. Preferably, segmented sexual aid tool 104 of FIG. 14 is radially symmetrical about a single centered axis 152, as shown. Although 2 middle portions 120 are generally preferred, as shown, the quantity of middle portions 120 may be selected to form a segmented sexual aid tool 104 of essentially any length preferred by the user (at least embodying herein wherein said at least one sexual-aid tool is structured and arranged to be length adjustable to any user-selected length using a plurality of said at least one middle segments). When assembled, as shown, segmented sexual aid tool 104 comprises a generally phallic shape.

It is sometimes preferred that such embodiments of segmented sexual aid tool 104 be produced using basic lathe techniques, for example, to allow for small production runs or hand-crafted production. More preferably, the depicted segmented sexual aid tool 104 is manufactured by at least one automated machining process, preferably utilizing a 3-axis (X, Y, and Z axis), programmable, computer numerically controlled (CNC) milling and lathe device. A 3-axes machining device typically has two axes for horizontal movement (X and Y) and one axis for vertical movement (Z). Preferably, such a three-axes milling machine is used for machining sexual aid tools 104 comprising a single centered axis 152, as shown. Three-axes milling machines are also used to make moderately complex shapes, as further described below. Upon reading this specification, those with ordinary skill in the art will now appreciate that, under appropriate circumstances, considering such issues as manufacturing preference, cost, structural requirements, available materials, technological advances, etc., other methods of machining such metals such as, laser cutting, hand machining, etc., may suffice.

FIG. 15 shows a side view of a multiple-axis segmented sexual aid tool 200 of the stress relief system 100 according to another preferred embodiment of the present invention. In contrast to the prior preferred embodiments, sexual aid tool 200 does not comprise a single longitudinal axis about which the outer surfaces revolve; rather, sexual aid tool 200 preferably comprises a complex outer configuration arising from the preferred use of one or more axially asymmetric subcomponents, as shown.

Preferably, sexual aid tool 200 comprises a plurality of segmented portions 206, both axially symmetric and axially asymmetric in physical shape, as shown. Preferably, the plurality of segmented portions 206 of sexual aid tool 200 are capable of being assembled and disassembled so that a user can, by selecting from available segments, change the size, shape, and function the tool. As in the prior depicted embodiments of sexual aid tool system 100, such selection is user-customizable simply by inter-attaching the segmented portions 206 in a different orientation, or by the addition or deletion of additional segmented portions 206 by the user. For example, choosing different segmented portions 206 may preferably add one or more unique protrusions 207, add a specific external surface texture 209, add a segment with a specific graphical feature 211, add a segment with indicia such as a logo 213, etc., as shown. In addition, preferred segmented portions 206 may comprise relatively complex shapes, such as the preferred axially asymmetric segmented portions identified herein as segmented portions 208, as shown.

In the preferred embodiment of FIG. 15, selected segmented portions 206 preferably comprise an axially symmetric first end portion 210, a generally axially symmetric second end portion 216, and at least two distinctly axially asymmetric middle portions 220 (comprising segmented portions 208), as shown. Each segmented portion 206 is preferably selectable from a plurality of unique segmented portions 206 with each selection having the potential of producing a unique assembled embodiment.

Preferably, the preferred axially asymmetric segmented portions 208 are produced using at least one automated multi-axis machining process. Segmented portions 208 are preferably produced using at least a 4-axis, computerized, numerical control (CNC) machine comprising hardware necessary to add a fourth axis to a 3-axis CNC machine. The additional fourth axis most commonly provides rotation along an axis parallel to the X-axis, although other configurations are also preferred. The preferred use of a 4-axis CNC machine allows machining features onto a curved surface, such as a cylindrical segmented portion 208, as the segmented portion 208 is rotated in the fourth axis. The preferred use of 4-axis CNC machining also allows machine tool access to the underside or sides of segmented portions 208 without repositioning the part to an alternate orientation.

Most preferably, segmented portions 208 are produced using at least a 5-axis computerized numerical control (CNC) machine. 5-axis CNC machining is preferably used to achieve highly complex three-dimensional contours. 5-axis CNC machining enables the machining of five sides of segmented portions 208 within a single work piece setup. 5-axis CNC machining comprises X, Y, and Z-axis working perpendicular to one another together with two additional rotating axes to provide maximum machining flexibility. Preferred complex three-dimensional embodiments of segmented portions 208 can only be efficiently formed utilizing 5-axis machining. For example, preferred embodiments of segmented portions 208 require the cutting tool to reach inside a convoluted segment to cut continuous interior channels. Furthermore, the production of complex three-dimensional exterior contours requires a high level of tool control afforded through the use of 5-axis CNC machining technology.

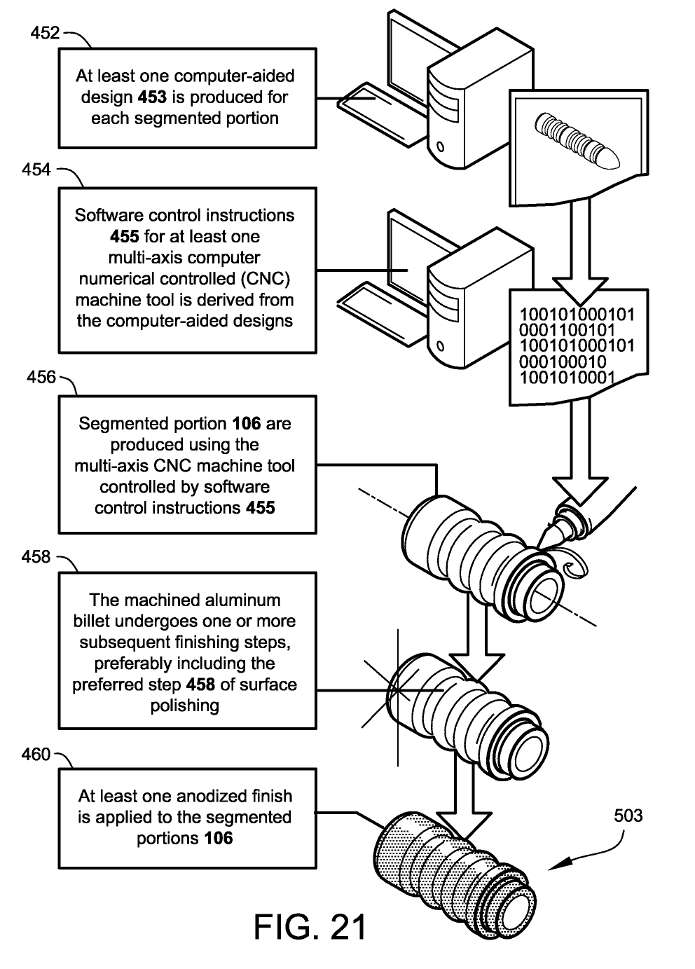

FIG. 21 shows a schematic flow diagram illustrating a preferred production method 450 of sexual aid tool system 100. In a preferred initial step 452 at least one computer-aided design 453 is produced for each segmented portion 106 preferably including segmented portions 208. The computer-aided designs comprise geometric data associated with the machining of specific preferred embodiments of segmented portion 106, preferably including geometric data associated with the machining of at least one distinctive physical characteristic to differentiate individual intercouplable segmented portion 106 by physical shape. Next, software control instructions 455 for at least one multi-axis computer numerical controlled (CNC) machine tool is derived from the computer-aided designs, as indicated in preferred step 454. The multi-axis, computer numerical, controlled machine tool comprises at least one of the above-described CNC machining technologies, and software control instructions 455 comprises code enabling its operation. Upon reading this specification, those with ordinary skill in the art will now appreciate that, under appropriate circumstances, considering such issues as manufacturing preference, cost, structural requirements, available materials, technological advances, etc., other software/hardware arrangements such as the use of integrated design/tool control applications, producing CAD models using scanning processes, etc., may suffice.

Next, the segmented portion 106 is produced using the multi-axis CNC machine tool controlled by software control instructions 455, as indicated in preferred step 456 (at least embodying herein producing at least one first end segment of such segmented sexual aid tool using at least one multi-axis computer numerical controlled machine tool controlled by such software control instructions; producing at least one second end segment of such segmented sexual aid tool using such at least one multi-axis computer numerical controlled machine tool controlled by such software control instructions; and producing at least one intermediate segment of such segmented sexual aid tool using such at least one multi-axis computer numerical controlled machine tool controlled by such software control instructions). As previously noted, a segmented portion 106 is formed by machining a solid block of material, most preferably in the form of an appropriately sized aluminum billet.

Depending on the capabilities of the CNC device, the segmented portions 106 may comprise an acceptable final external finish. Preferably, once CNC machining is completed, the machine aluminum billet undergoes one or more subsequent finishing steps, preferably including the preferred step 458 of surface polishing. It is noted that not all user-selected finishes require preferred step 458. For example, a heavily patterned surface finish may not require polishing prior to application of the pattern.

A preferred customization feature of the stress relief system 100 is the ability of a user to generate custom embodiments by selecting combinations of segmented portions 106 based on segment color. Most segmented portions 106 are preferably surface treated with one or more durable finishes and preferably comprise a plurality of colors. In an additional preferred step 460 of production method 450, at least one anodized finish is applied to the segmented portions 106. More specifically, the metal is preferably coated with a protective or decorative oxide like Iridite®. Iridite® is a preferred brand name for a chromate-producing product that belongs to MacDermid Inc. Alodine® 1200S is a similar preferred product produced by Henkel® North America.

In an alternate preferred step 470 of production method 450, data associated with at least one custom design to be integrated within at least one custom intercouplable segmented portion 106 (at least embodying herein at least one custom intercouplable segment) is used to generate a custom intercouplable segmented portion 106. The preferred process of receiving the custom design is further explained in a subsequent preferred method related to monetizing the present invention. In brief, there are several preferred options for the supplying of such custom data to the manufacturer of the custom intercouplable segmented portion 106.

In an alternate preferred step 470, at least one custom computer-aided design for such custom intercouplable segmented portion 106 is produced based on the received custom data, as indicated in preferred step 472. As part of the step, a “proof” may be produced to allow the manufacturer and end customer to review the potential design prior to fabrication. Preferably, software control instructions for the multi-axis CNC machine tool are derived from the custom computer-aided design, as indicated in preferred step 474. Next, as indicated in preferred step 476, at least one custom intercouplable segment is produced using the CNC machine tool controlled by the software control instructions.

In the present preferred method, the custom design may preferably comprise a surface engraving such as a name, a symbol or logo, a personalized message, a custom surface pattern, the specification of a segment comprising a non-standard length or diameter, etc. Upon reading this specification, those with ordinary skill in the art will now appreciate that, under appropriate circumstances, considering such issues as manufacturing preference, cost, technological advances, etc., other custom data arrangements, such as the utilization of complex designs based on three-dimensional computer models, etc., may suffice.

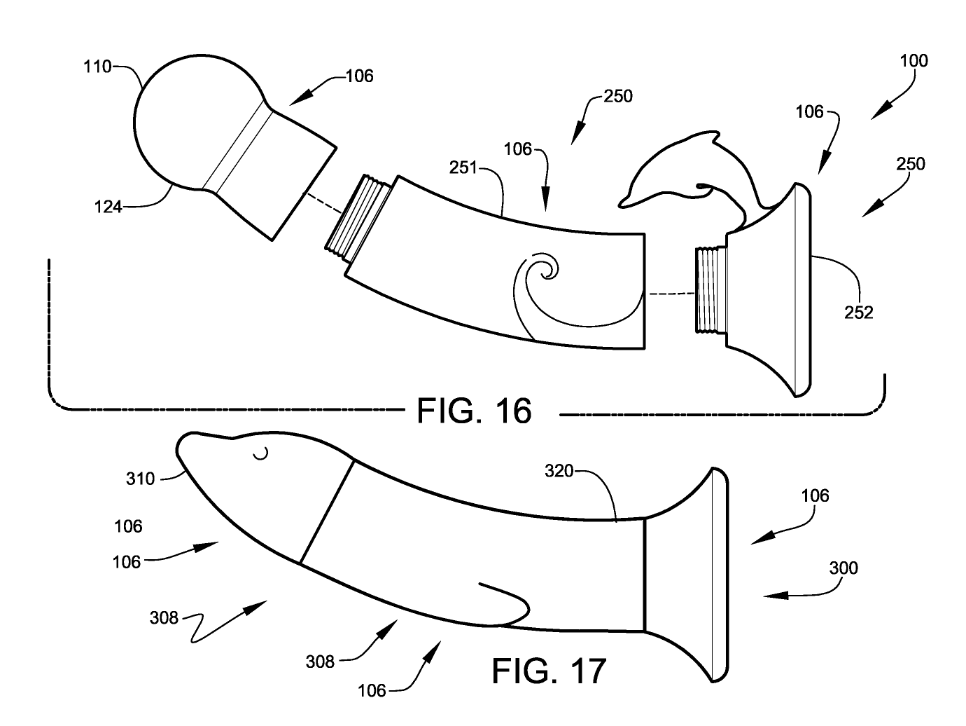

FIG. 16 shows a side view of another multiple-axis segmented sexual aid tool 250 of the stress relief system 100 according to another preferred embodiment of the present invention. FIG. 17 shows a side view of another multiple-axis segmented sexual aid tool 300 of the stress relief system 100 according to yet another preferred embodiment of the present invention. FIG. 16 and FIG. 17 further illustrate alternate segmented portions preferably containing non-uniform three-dimensional shapes generated through 5-axis CNC machining. FIG. 16 comprises a preferred example combination of axially-symmetric and axially-asymmetric segments, as shown. In FIG. 16, the middle portion 251 and second-end portion 252 comprise axially asymmetric segmented portions 308, as shown. In FIG. 17, the first-end portion 310 and middle portion 320 comprise axially asymmetric segmented portions 308, as shown.

The preferred materials and production methods of the stress relief system 100 allows the depicted embodiments to expand their inherent utility to encompass visually-pleasing sculptural forms. More specifically, preferred embodiments of the stress relief system 100 may express a range of iconographies deriving from diverse range of visual sources including, classical themes, contemporary references, biomorphic shapes (as shown), etc.

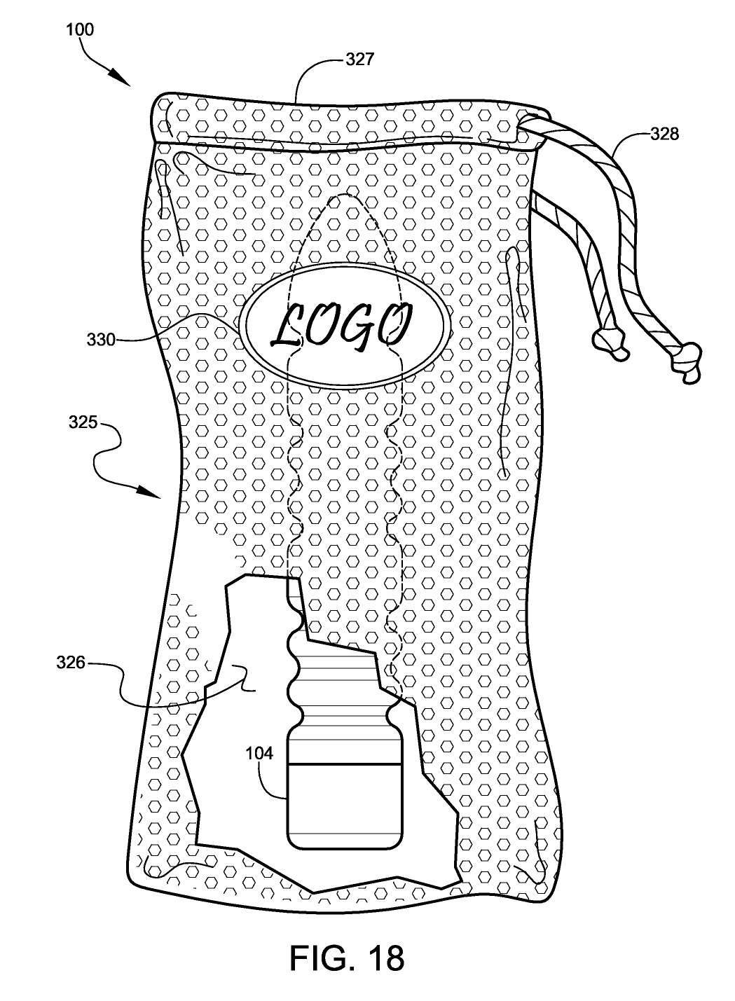

FIG. 18 shows a side view, partially in section, of a preferred storage pouch 325 for the sexual aid tool embodiments, according to a preferred embodiment of sexual aid tool system 100. Storage pouch 325 provides a convenient and appropriately constructed storage container for the various components of sexual aid tool system 100, including segmented sexual aid tool 104. Preferably, storage pouch 325 comprises a flexible bag having at least one internal storage compartment 326, at least one opening 327 to allow access to storage compartment 326, and at least one closure 328 to assist in closing opening 327 to retain stored items within storage compartment 326.

Preferably, storage pouch 325 comprises indicia 330, such as, for example, company logos, trade names and decorative designs to entice a consumer to purchase the system. For example, a preferred embodiment of storage pouch 325 is constructed from a decorative fabric, as shown. Alternately preferably, customer-selected indicia are applied to storage pouch 325, such as, for example, indicia that relates to at least one individual or at least one activity. Upon reading this specification, those with ordinary skill in the art will now appreciate that, under appropriate circumstances, considering such issues as manufacturing preference, cost, structural requirements, available materials, technological advances, etc., other stress relief system component containers such as, cushioned boxes, metal containers to match the system components, etc., may suffice.

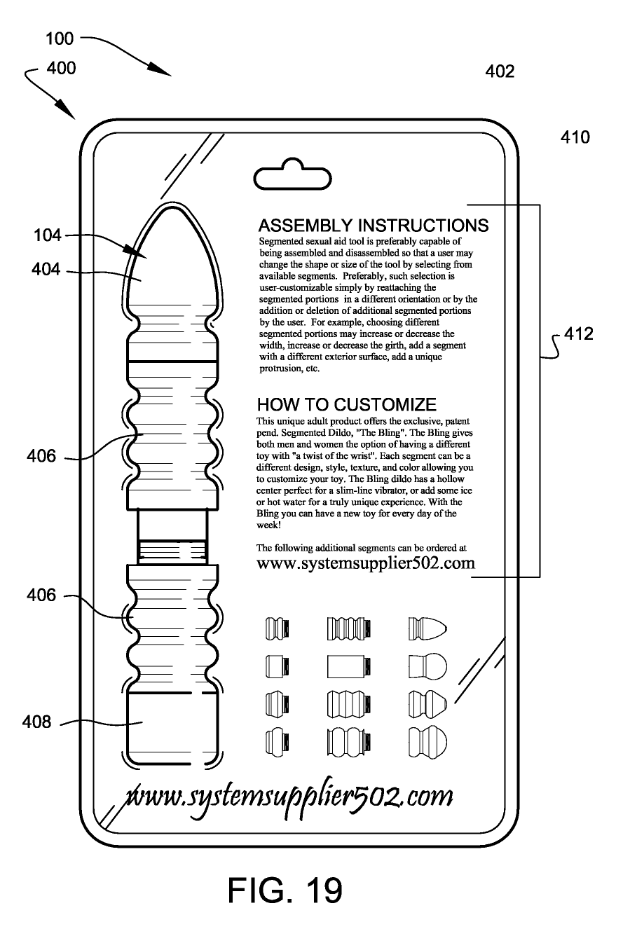

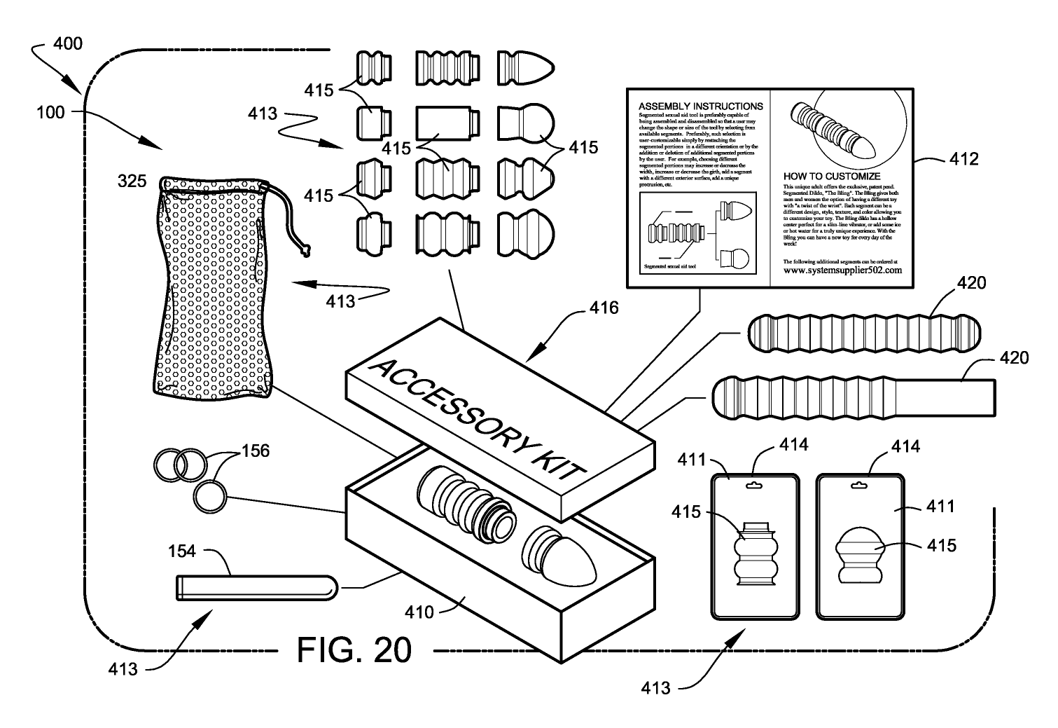

FIG. 19 shows a schematic diagram illustrating preferred items making up a preferred kit system 400, according to a preferred embodiment of the present invention. Preferred embodiments of kit system 400 comprise predefined combinations groupings of system components usable to form one or more segmented sexual aid tools. In addition, preferred kit embodiments of the stress relief system 100 comprise additional “accessory” kits and in allowing a user to customize, repair, or otherwise modify an existing segmented sexual aid tool Preferably, kit system 400 comprises a starter kit 402, preferably offered with at least three segments: a primary top segment 404, a primary middle segment 406, and a primary base segment 408, as shown. In combination, the primary top segment 404, the primary middle segment 406, and the primary base segment 408 enable the user to assemble a basic but complete segmented sexual aid tool (at least embodying herein at least three intercouplable segments usable to assemble at least one user-assembled segmented sexual aid tool), such as the segmented sexual aid tool 104 described in FIG. 1. Starter kit 402 also preferably comprises outer packaging 410 to hold the three intercouplable segments, and instructions 412 for assembling the three intercouplable segments into the segmented sexual aid tool embodiment, as shown. Alternately preferably, outer packaging 410 comprises the storage pouch 325 of FIG. 18, preferably containing the above-described segments along with a sheet of instructions 412. Upon reading this specification, those with ordinary skill in the art will now appreciate that, under appropriate circumstances, considering such issues as design preference, user preferences, marketing preferences, cost, structural requirements, available materials, technological advances, fine packaging such as wooden boxes, etc., other kit arrangements such as the inclusion of marketing materials, photos of additional accessories, potential uses, etc., may suffice. FIG. 20 shows a schematic diagram illustrating a preferred accessory kit 416 and preferred examples of individually packaged components 414, preferably comprising one or more add-on components 413, usable to augment the starter kit 402 of FIG. 19.

Preferably, a user may later purchase “add-on” accessory kits 416 or individually packaged components 414 to augment starter kit 402, or to customize to the user's needs, other pre-existing embodiments of stress relief systems 100. Preferred embodiments of the accessory kit 416 preferably include one or more of the following preferred items; additional intercouplable segments 415 having features to augment function, sexual aid elements 154 (or other devices insert-able within longitudinal internal chamber 150), a decorative pouch 325, repair items preferably such as replacement O-rings 156, instructions 412, and at least one outer package 410 to hold the contents of the accessory kit 416.

Individually packaged components 414 preferably comprise one additional intercouplable segment 415 enclosed within an individual outer package 411, as shown. Preferred embodiments of both outer packaging 410 and individual outer package 411 preferably include information relating to possible user-customization of the user-assembled segmented sexual aid tools using the accessory kits 416, individually packaged components 414, custom designed segments, etc., and ordering information for assisting ordering of such products. Outer packaging 410 and individual outer packaging 411 preferably comprise protective encapsulations with retail markings (bar codes), descriptions, order information, etc. Both outer packaging 410 and individual outer packaging 411 preferably comprise known packaging formats, such as thermoformed blisters, clamshells, stand-up, shrink wrapped hang cards, printed boxes.

Preferably, alternate preferred embodiments of accessory kit 416 may also comprise at least one non-segmented sexual aid 420, as shown. Preferably, non-segmented sexual aid 420 comprises a pre-selected shape and dimension, as shown. Preferably, non-segmented sexual aid 420 is machined, preferably utilizing a multi-axis CNC lathe, preferably using at least one metal element, preferably comprising polished anodized aluminum. Upon reading this specification, those with ordinary skill in the art will now appreciate that, under appropriate circumstances, considering such issues as manufacturing preference, cost, structural requirements, available materials, technological advances, etc., other machinable materials such as, stainless steel, titanium, nickel, platinum, etc., may suffice. Preferably, non-segmented sexual aid 420 may be embossed, engraved or otherwise surface customized.

It is noted that, starter kit 402, accessory kit 416, and individually packaged components 414 may preferably consist of axially symmetrical and axially asymmetrical segments. It is also noted that preferred embodiments of kit system 400 preferably include segments that are pre-selected in number, shape, color, and texture by the system supplier 502 of sexual aid tool system 100, as described in FIG. 21.

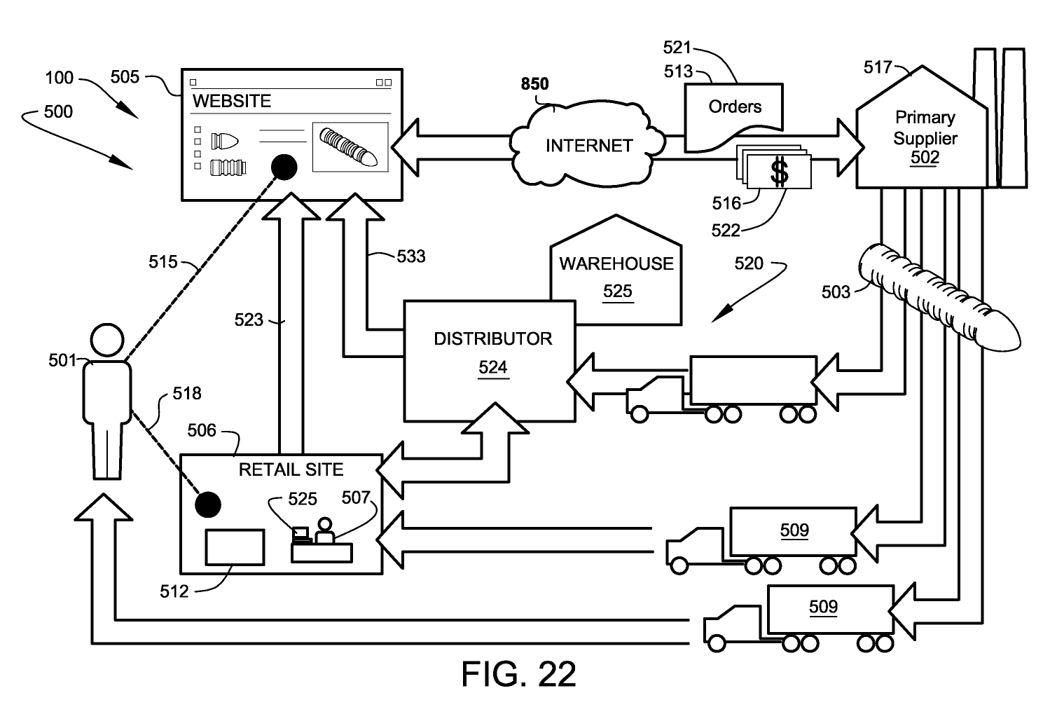

FIG. 22 shows an overall schematic diagram, illustrating a preferred sexual-aid business-architecture, according to a preferred monetization method 500 of sexual aid tool system 100. In the following descriptions, it is helpful to refer to the prior figures for reference numbers cited in the following teachings.

Preferably, an end consumer 501 purchases, either directly or indirectly from at least one primary supplier 502, user-customizable products 503 preferably ranging from pre-assembled segmented sexual aid tools to kits containing additional tool segments, parts, and accessories used to modify or enhance the functionality of existing segmented sexual aid tools. Within the present disclosure, user-customizable products 503 shall at least include the above-described embodiments of sexual aid tool system 100, preferably including segmented sexual aid tools 104, segmented portions 106, sexual aid elements 154, decorative pouches 325, sexual aid tools 250, sexual aid tools 300, starter kits 402, accessory kits 416, etc.

According to the preferred monetization method 500, end consumer 501 is afforded at least two preferred means for acquiring customizable products 503. First, end consumer 501 may preferably acquire such customizable products 503 through a direct purchase transaction 515 wherein primary supplier 502 sells customizable products 503 directly to the end consumer 501, as shown. In a preferred arrangement, primary supplier 502 is the principle fabricator of customizable products 503, preferably operating factory 517 to convert raw materials into customizable products 503. Direct purchase transaction 515 preferably generates order 513 and at least one associated payment 516, which is directed to primary supplier 502, as shown. Direct purchase transaction 515 is preferably conducted by mail, alternately preferably by facsimile (fax), alternately preferably by telephone, most preferably using at least one Internet website 505, as shown. The movement of the purchased customizable products 503 to the end consumer 501 is preferably routed directly from the factory 517 (or factory-controlled facility) by way of a direct shipping channel 509, as shown. Primary supplier 502 preferably coordinates packaging and shipping of the purchased customizable products 503.

In the second preferred purchasing arrangement, end consumer 501 may preferably acquire customizable products 503 through an indirect channel, preferably comprising a retail purchase transaction 518 conducted within a physical retail site 506, as shown. The retail site 506 preferably functions as a preferred purchasing-interface within which end consumer 501 can select, purchase, and immediately receive one or more of the customizable products 503 of the sexual aid tool system 100.

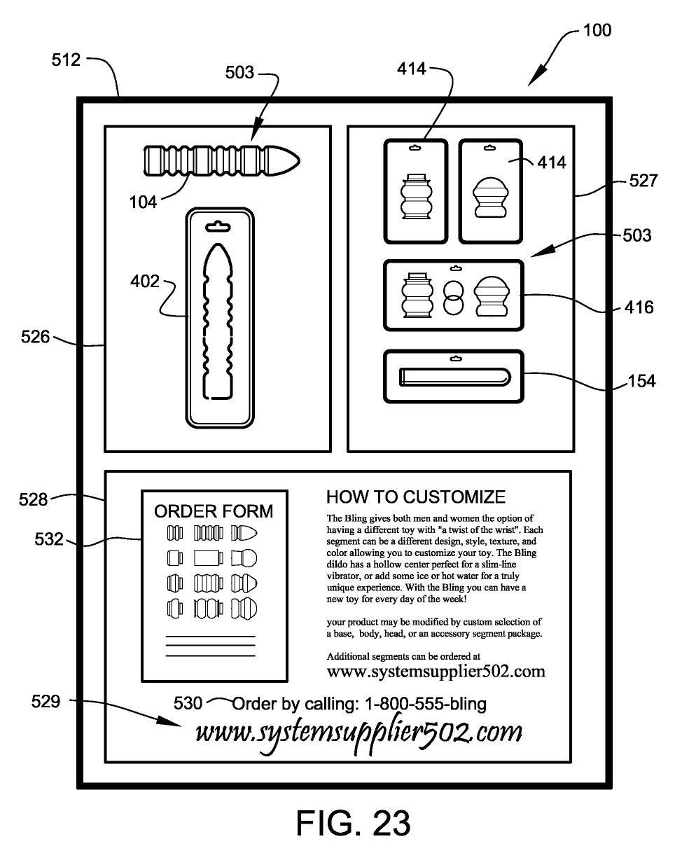

Retail purchase transaction 518 within retail site 506 is preferably facilitated by a specially designed product display fixture 512 structured and arranged to assist the end consumer 501 in the selection of customizable products 503 and in future ordering of additional customizable products 503, as further described in FIG. 23 (at least embodying herein at least one customer-selection interface structured and arranged to enable selecting of at least one custom combination of such user-interchangeable sexual-aid-tool parts usable to assemble at least one custom segmented sexual aid tool; and at least embodying herein at least one customer-order interface structured and arranged assist in generating at least one order of such user-interchangeable sexual-aid-tool parts). Preferably, the retail site 506 further comprises at least one customer-payment interface 525, preferably in the form of a payment counter, checkout counter, service desk, or equivalent fixture designed to assist in completing retail purchase transaction 518. In addition, payment for special orders, of customizable products 503 not directly available within retail site 506, is also accomplished at customer-payment interface 525.

The retail site 506 is preferably operated by a retailer 507 that takes title to customizable products 503 and resells them to end consumer 501. Preferred examples of retail site 506 include established adult product chains, but also preferably include the many smaller independent retail stores.

In a preferred arrangement, retailer 507 initiates a wholesale purchase transaction 523 of customizable products 503 by sending an order 521 and at least one associated payment 522 to primary supplier 502, as shown. The wholesale purchase transaction 523 is preferably conducted by mail, alternately preferably by facsimile (fax), alternately preferably by telephone, most preferably using the Internet website 505, as shown.

The movement of the purchased customizable products 503 to the retail site 506 may preferably be direct from the factory 517 by means of the direct shipping channel 509, or alternately preferably, through the distribution channel 520, as shown. Distribution channel 520 preferably comprises at least one distributor 524 acting as an intermediary between retailer 507 and primary supplier 502. Preferably, the primary supplier 502 sells and ships to the distributor 524, as shown. The distributor 524 then preferably sells and ships to the retailer 507, as shown. It is noted that this alternate process may preferably occur in one or multiple stages. Preferably, distributor 524 does not manufacture customizable products 503, but purchases the customizable products 503 from primary supplier 502 through wholesale purchase transaction 533, as shown. Wholesale purchase transaction 533 is most preferably conducted using the Internet website 505, as shown. Distributor 524 may preferably take the title of the product but elect to have the primary supplier 502 “drop ship” orders directly to the retailer 507. Alternatively, a large volume distributor may preferably maintain a finished goods inventory within warehouse 525, which is used to fulfill orders from a large-volume retailer 507.

In all of the above-described distribution methodologies, primary supplier 502 utilizes at least one rapid manufacturing technique to manufacture the ordered products essentially “on demand”, preferably executing product production after confirmation of both a customer order and an associated customer payment, more preferably after receipt of both the customer order and associated customer payment (at least embodying herein providing for the manufacture of such at least one order of such user-interchangeable sexual-aid-tool parts essentially on receipt of such at least one custom order and such payment). One preferred rapid manufacturing technique comprises the use of the previously-described multi-axis CNC machine tool. This highly preferred production arrangement allows primary supplier 502 to meet customer demand while minimizing, or more preferably, eliminating inventory and storage levels. This preferably reduces initial production costs as well as costs associated with storing and maintaining such pre-order inventories.

FIG. 23 shows a schematic diagram illustrating a preferred retail purchase transaction 518 and a subsequent direct purchase transaction 515 by the end consumer 501, according to the preferred monetizing method 500 of FIG. 22. As previously stated, retail site 506 preferably functions as a preferred purchasing-interface within which end consumer 501 can select, purchase, and immediately receive one or more of the customizable products 503 of the sexual aid tool system 100. Retail site 506 preferably comprises a “brick-and-mortar” store offering customizable products 503 for retail sale. Such customizable products 503 are preferably displayed in one or more specialized product display fixtures 512 located within the sales floor of retail site 506, as shown. The product display fixture 512 most preferably comprises a vendor-supplied store fixture of proprietary design, preferably made available to retailer 507 by the system supplier 502. Product display fixture 512 preferably takes advantage of the interactive adaptability of the customizable products 503 to increase consumer interest in the product.

FIG. 23 schematically diagrams a preferred organizational arrangement of the in-store product display fixture 512. The product display fixture 512 preferably comprises at least one first display area 526 adapted to display customizable products 503 in a substantially assembled condition. More specifically, the first display area 526 is adapted to clearly demonstrate to end consumer 501 example embodiments of sexual aid tool system 100 by displaying one or more pre-assembled segmented sexual aid tools, such as the segmented sexual aid tool 104 of FIG. 1. The assembled segmented sexual aid tools of first display area 526 preferably comprise purchasable products, and may preferably comprise one or more starter kits 402. Preferred packaging arrangements for starter kits 402 preferably enhance the display of the assembled or semi-assembled products, and may preferably comprise transparent blister packs, transparent clamshells, etc.

Product display fixture 512 preferably comprises at least one second display area 527 adapted to display customizable products 503 in the form of individually packaged components 414, accessory kits 416, and sexual aid elements 154, as shown (at least embodying herein displaying in at least one second display, a plurality of such user-interchangeable sexual-aid-tool parts). The customizable products 503 of the second display area 527 also preferably comprise purchasable products.

Product display fixture 512 preferably comprises at least one third display area 528, preferably adjoining first display area 526 and a second display area 527, preferably containing instructional information relating to possible user-customization of the segmented sexual aid tools using the customizable products 503 of first display area 526 and a second display area 527. This information may preferably include illustrations, photographs, written descriptions, multimedia presentations (onsite video), etc. In addition, product display fixture 512 preferably comprises product ordering information 529 for assisting end consumer 501 to order additional customizable products 503, not immediately available within retail site 506 (at least embodying herein displaying within at least one of such at least one first display, such at least one second display, and such at least one third display, product ordering information for assisting ordering of at least one user-interchangeable sexual-aid-tool part selected from such plurality of user-interchangeable sexual-aid-tool parts). The product ordering information 529 may preferably include a product catalog and information directing the end consumer 501 to at least one ordering site.

Preferably, the product ordering information 529 comprises at least one telephone number 530 of at least one segmented sexual aid tools product fulfillment entity, preferably comprising the system supplier 502, or alternately preferably, distributor 524. Alternately preferably, the product ordering information 529 comprises at least one order form 532 usable within retail site 506. Most preferably, the product ordering information 529 comprises an Internet website address associated with website 505.

The product display fixture 512 preferably comprises fixturing components that can be used to display or support customizable products 503 as a display attached to a wall, or as a freestanding display. The product display fixture 512 may preferably comprise a Point-of-Purchase (POP) display comprising a movable display preferably placed in impulse areas near the checkout (customer-payment interface 525) or near other featured merchandise.

In a preferred retail purchase transaction 518, end consumer 501 is assisted in the selection of customizable products 503 by interaction with product display fixture 512 within the retail site 506. End consumer 501 preferably utilizes the retailer's checkout (customer-payment interface 525) to complete the retail purchase transaction 518 whereby end consumer 501 acquires the customizable products 503 selected from within product display fixture 512. In addition, the end consumer 501 may use the retailer 507 as a channel to order additional customizable products 503 not immediately available within product display fixture 512. Preferably, the end consumer 501 unpacks the customizable products 503 revealing product care and use instructions along with ordering information to assist ordering of additional customizable products 503. This preference is intended to reinforce the end consumer's interest in customization of his or her existing segmented product. In a highly preferred arrangement, end consumer 501 is directed to the online website 505 where additional products can be purchased through a direct purchase transaction 515, as further described below.

Recently, a wide range of interactive devices have been developed to provide information to users by means of communications networks. These interactive devices include, for example, computers connected to various computer-based on-line services, interactive kiosks, interactive television systems, data-enabled mobile phones, and a variety of other wired and wireless data devices.

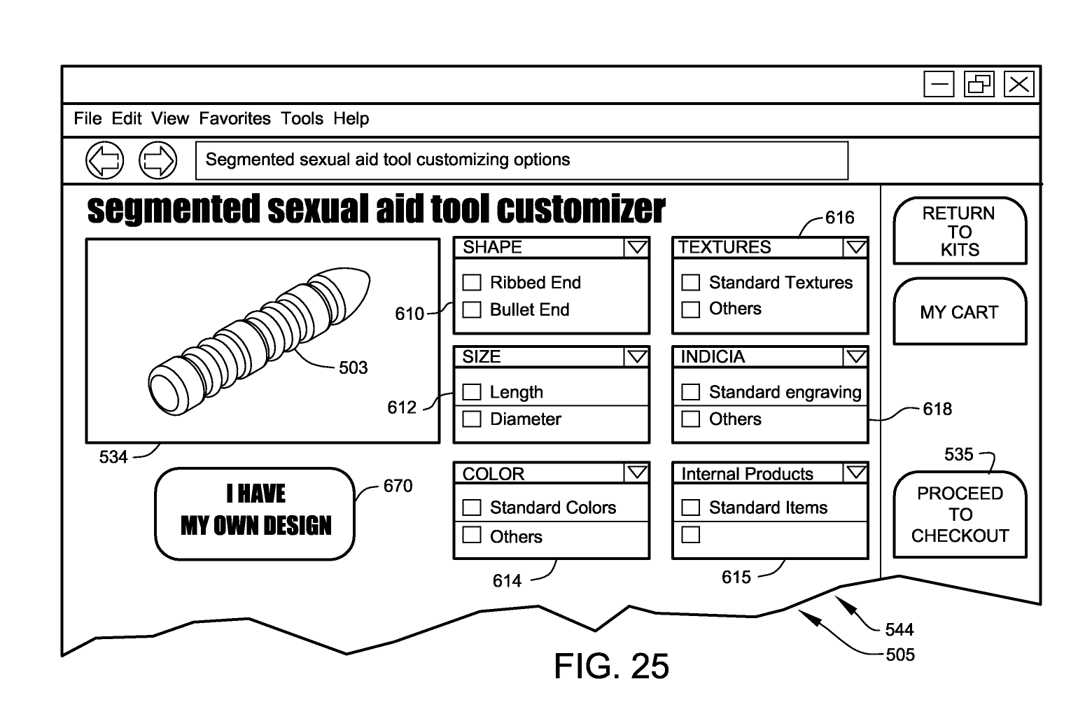

In general, most computer on-line services are accessed via the Internet. The Internet is a global network of computers. One popular component of the Internet is the World Wide Web, or the “Web”. The World Wide Web contains computers that display graphical and textual information. Computers that provide information on the World Wide Web are typically called “Web sites.” A Web site is defined by an Internet address that has an associated electronic page, often called a “web page”. Generally, a web page is an electronic document that organizes the presentation of text, graphical images, audio and video into a desired display. The applicant's website 505, as depicted in FIG. 25, is such a web page preferably operating within the World Wide Web. The end consumer 501 may access the website 505 using special interface software, called “browser” software, installed within the end consumer's computer, mobile phone, or other access device.

Information exchanged over the Internet is typically encoded in Hypertext Markup Language (HTML) format. The HTML format is a scripting language that is used to generate the web pages for different content providers. In this preferred setting, the content provider is system supplier 502 who places information (content) on the Internet so that potential end consumers can access it. The HTML format is a set of conventions for marking different portions of a document so that each portion appears in a distinctive format. For example, the HTML format identifies or “tags” portions of a document to identify different categories of text (e.g., the title, header, body text, etc.).

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites).

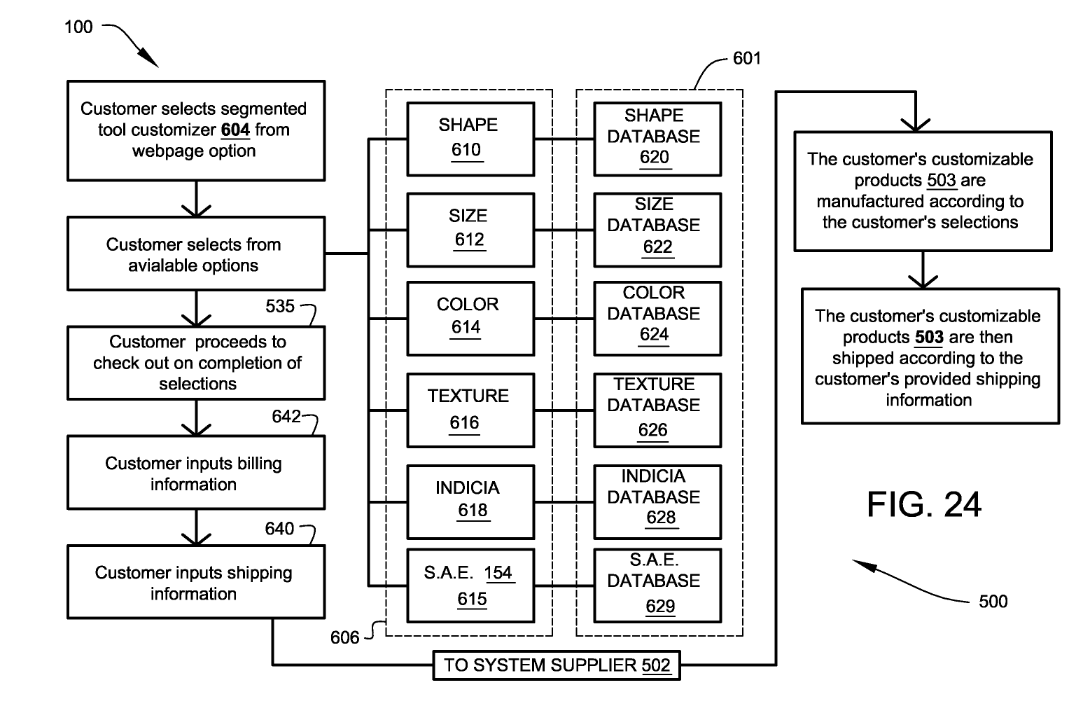

FIG. 24 shows a processing flowchart involving user input data and user-provided specifications, according to the preferred monetization method 500 of FIG. 22. FIG. 25 shows a schematic illustration of a user input data screen 550 of website 505, according to the preferred monetization method 500 of FIG. 22. The preferred processes of monetization method 500 may be accomplished using a number of physical and virtual implementations; however, the preferred processes of monetization method 500 are most preferably implemented on at least one web page 544 of website 505. More specifically, both direct purchase transactions 515 by the end consumer 501 and wholesale purchase transactions 523 by the retailer 507 and the distributor 524 are most preferably conducted using the Internet website 505, as shown.

As shown in FIG. 24 and FIG. 25, website 505 is preferably organized to facilitate the selection and purchasing of customer selected combinations of the customizable products 503 (at least embodying herein providing to at least one customer, at least one purchasing-interface for the purchasing of user-interchangeable sexual-aid-tool parts). It is noted that the wholesale purchases made by the retailer 507 and the distributor 524 may preferably occur through a substantially similar but separate set of web pages of website 505, preferably accessed through at least one predefined wholesale customer authorization process.

Customer-selected segmented sexual aid tool customizer 604 is preferably implemented within the web page 544 of website 505 (see also FIG. 24). Customer-selected segmented sexual aid tool customizer 604 preferably utilizes customer selections drawn from at least one database 601 containing possible selection options. Such selection options preferably include segment shape, segment size, segment color, segment texture, and segment indicia, as shown. Furthermore, the database 601 preferably contains lists of sexual aid elements 154 that may be used with the customers assembled product.

From within customer-selected segmented sexual aid tool customizer 604, the customer preferably chooses one or all of the customization options 606, as shown. More specifically, the customer proceeds through a series of selection boxes as follows: “select shape of segment” 610, “select size of segment” 612, “select color of segment” 614, “select surface texture of segment” 616, and “select surface indicia of segment” 618 (at least embodying herein displaying in at least one second display, a plurality of such user-interchangeable sexual-aid-tool parts).

The “select shape of segment” 610 preferably links to at least one database 620 comprising all shape options available to the customer. The “select size of segment” 612 preferably links to at least one database 622 containing the different segment size options available to the customer. The “select color of segment” 614 preferably links to a database 624 comprising the different segment color options available to the customer. The “select surface texture of segment” 616 preferably links to a database 626 comprising the different segment surface texture options available to the customer (available options for segment surface texture include the option of having no texture). The “select surface indicia of segment” 618 preferably links to a database 628 comprising the different segment surface indicia options available to the customer (available options for segment surface indicia preferably includes the option of having no surface indicia).

Optionally preferably, website 505 comprises at least one “select sexual aid elements” interface 615 whereby the customer selects, for purchasing through the website 505, sexual aid elements 154 that may be used with the customer's assembled product. The “select sexual aid elements” interface 615 preferably links to a database 629 comprising the system-compatible, sexual aid elements 154 available to the customer through system supplier 502. Upon reading this specification, those with ordinary skill in the art will now appreciate that, under appropriate circumstances, considering such issues as design preference, customer preferences, marketing preferences, cost, structural requirements, available materials, technological advances, etc., other web site arrangements, such as, for example, directing a customer to compatible third-party suppliers of sexual aid elements, etc., may suffice.

Preferably, possible selections from the database are displayed within the respective webpage selection interfaces, as shown.

Preferably, the customer next selects “proceed to checkout interface 535 to complete inputting of billing information 642, shipping information 640, and special instructions, if any (at least embodying herein displaying within at least one of such at least one first display, such at least one second display, and such at least one third display, product ordering information for assisting ordering of at least one user-interchangeable sexual-aid-tool part selected from such plurality of user-interchangeable sexual-aid-tool parts; and at least embodying herein providing at least one purchasing-interface to assist purchasing of such at least one user-interchangeable sexual-aid-tool part).

Preferably the entire customer's selected and input information is preferably directed to the system supplier 502, as shown. The customer's customizable products 503 are then manufactured according to the customer's selections. The customer's customizable products 503 are then shipped according to the customer's provided shipping information (at least embodying herein, providing for fulfillment of such at least one user-interchangeable sexual-aid-tool part).

The web page 544 preferably utilizes text, and graphical images 534, as shown, to assist the customer in navigating the product selection options. Preferably, the text and graphical images 534 include instructional information relating to possible user-customization of such customizable products 503, as shown (at least embodying herein displaying in at least one third display, adjoining such at least one first display and such at least one second display, information relating to possible user-customization of such segmented sexual aid tools using such user-interchangeable sexual-aid-tool parts). The graphical images 534 may be implemented such that an assembled embodiment representing the customer's selections are presented in “real-time”, allowing the customer to review his or her selection prior to purchase (at least embodying herein displaying in at least one first display, such segmented sexual aid tools in a substantially assembled condition). Alternate preferred embodiments of the web page 544 preferably contain additional “enhanced” content, preferably including audio and video, to further assist the customer in understanding the use of the system and to assist the customer in completing his or her selection and purchase.

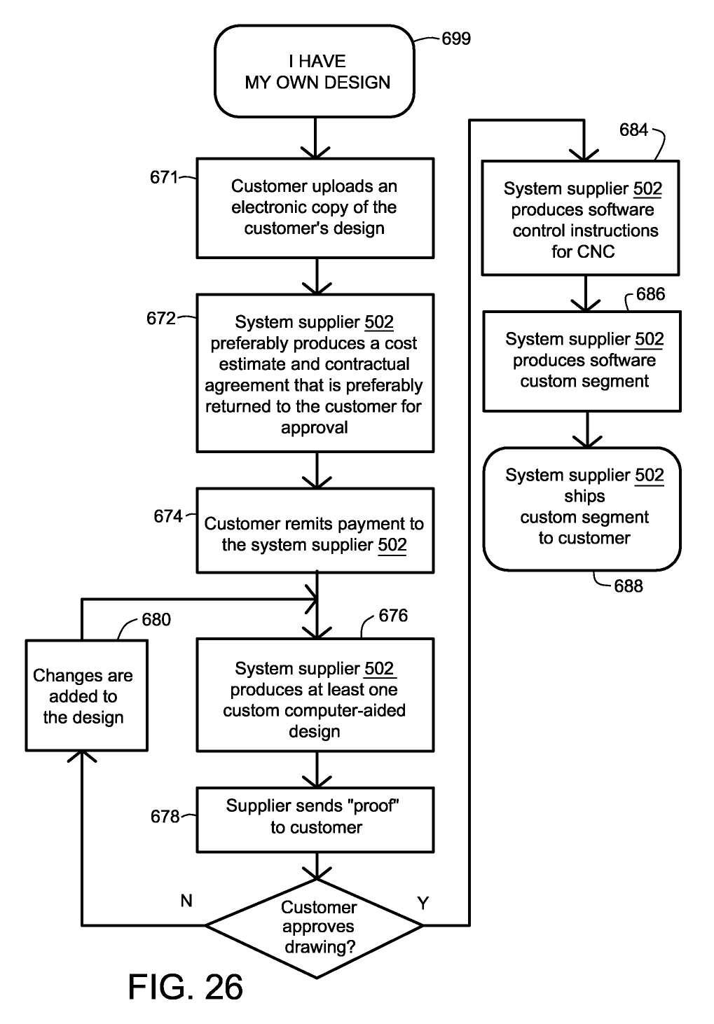

FIG. 26 shows a processing flowchart illustrating the preferred steps for user customization involving the uploading of customer input data, according to alternate preferred processes of method 669. To begin the process, a customer selects customization screen option 670 within web page 544 (see FIG. 25), as indicated in preferred step 699. Customization screen option 670 is preferably given an appropriate identifier, such as the text “I have my own design”, as shown. Next, as indicated in preferred step 671, the customer uploads to the Internet website server 504 of system supplier 502 an electronic copy of the customer's design. Such an electronic copy of the customer's design may include a digital drawing or description of a surface engraving such as, for example, a name, a symbol or logo, a personalized message, a custom surface pattern, the specification of a segment comprising a non-standard length or diameter, etc.

On receiving the customer's electronic data, the system supplier 502 preferably produces a cost estimate and contractual agreement that is preferably returned to the customer for approval, as indicated in preferred step 672. If the customer agrees to the conditions of the agreement the customer remits payment to the system supplier 502, as indicated in preferred step 674. Preferably, the interaction between systems supplier 502 and the customer may be conducted through the website 505, or alternatively preferably, may be conducted by e-mail correspondence.

The system supplier 502 preferably produces, based on the received custom data, at least one custom computer-aided design for a custom intercouplable segmented portion 106, as indicated in preferred step 676 (see also preferred step 472 of the production method presented in FIG. 21). Preferably, the system supplier 502 provides the customer with an electronic “proof” comprising a depiction of the custom intercouplable segmented portion 106 to be manufactured, as indicated in preferred step 678. Preferably, such an electronic proof may be provided through the website 505, or alternatively preferably may be sent to the customer by e-mail correspondence.

Next, the customer reviews the proof to confirm that the design has been appropriately integrated within the custom intercouplable segmented portion 106. If the customer has changes or comments, he or she forwards the information to the system supplier 502, as indicated in preferred step 680. The manufacturer then incorporates the suggested changes into the design, preferably by returning to preferred step 676, as shown.

Once the customer approves the design, the system supplier 502 preferably produces software control instructions for the multi-axis CNC machine tool, as indicated in preferred step 684. Next, as indicated in preferred step 686, one or more custom intercouplable segments 106 are produced, preferably using the CNC machine tool controlled by the software control instructions. Finally, the custom intercouplable segments 106 are packaged and shipped to the customer, as indicated in preferred step 688. Upon reading this specification, those with ordinary skill in the art will now appreciate that, under appropriate circumstances, considering such issues as design preference, user preferences, marketing preferences, cost, structural requirements, available materials, technological advances, etc., other process sequences and arrangements such as, for example, producing a proof prior to the customer entering into a contractual agreement, receiving partial payment prior to fabrication and final payment after customer delivery, utilizing alternate fabrication methods, etc., may suffice.

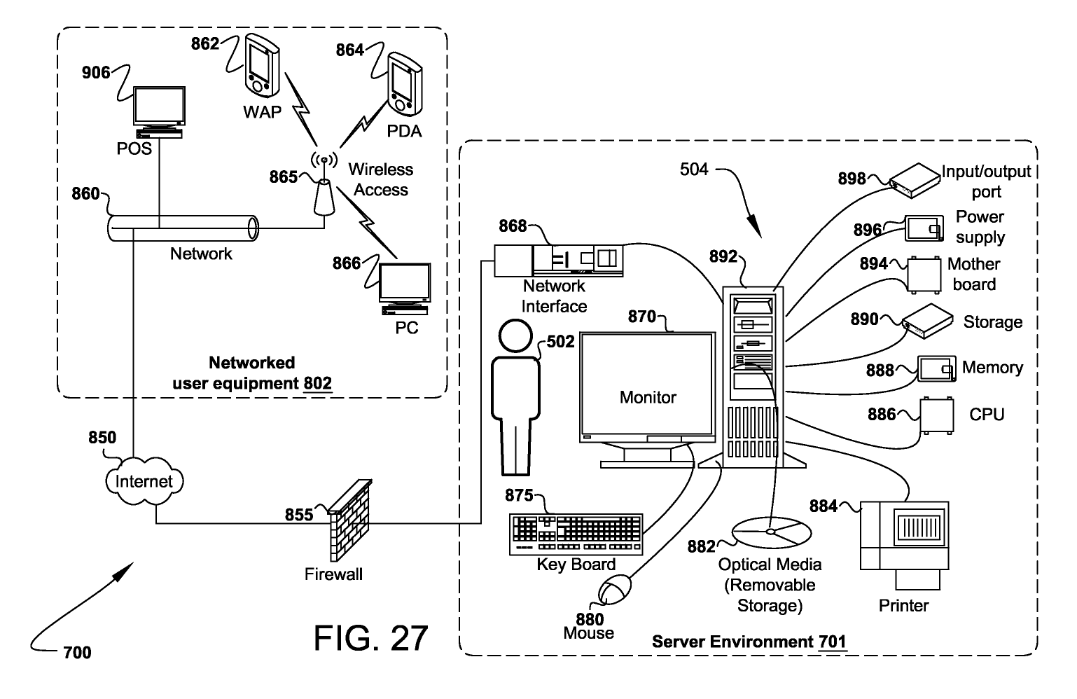

FIG. 27 shows a schematic block diagram of a typical processor configuration for an implementation of the preferred monetization method of FIG. 22. Preferably, hardware environment 700 comprises server environment 701 and networked user equipment 802, as shown. Additionally, preferably as shown, hardware environment 700 comprises at least one Internet website server 504 used by system supplier 502, preferably comprising: at least one input/output port 898, power supply 896, motherboard 894, chassis 892, storage 890, memory 888, central processing unit (CPU) 886, printer 884, removable storage medium 882, mouse 880, keyboard 875, monitor 870, network interface 868, wireless network access 865, network 860, firewall 855, and internet connection 850. Further preferably, as shown, the networked user equipment environment 602 comprises at least one user device preferably including: point of sale machine 906, web enabled device (WAP) 862, personal data assistant (PDA) 864, and personal computer (PC) 866. It is noted that the personal data assistant 864 preferably includes devices such as mobile phones, and the like. Upon reading the teachings of this specification, those with ordinary skill in the art will now understand that, under appropriate circumstances, considering issues such as changes in technology, user requirements, etc., other monetizing service oriented architectures, such as, for example, monetizing peer-to-peer network architectures, billing and settlement architectures yet to be developed, etc., may suffice.

Preferably, the hardware environment 700 may be used to enable data-flows preferably across a multi-layer architecture, preferably including client machine tiers, connectivity tiers (represented herein as Internet 850 with the firewall 855), presentation tiers (such as ecommerce servers or messaging servers), application (business) tiers, and database tiers (such as database servers containing data related to the customizable products 503, customer data, etc.). Upon reading the teachings of this specification, those with ordinary skill in the art will now understand that, under appropriate circumstances, considering issues such as changes in data communications architectures and computing technology, etc., other multi-layered data communications and computing constructs including, such as, for example, interlaced N-tier communications and computing architectures yet to be developed, etc., may suffice.

Preferably the chassis 892 of the server environment 703, as shown, houses all components that make up the server environment 703 and provides at least one input/output port 898.

The preferred motherboard 894 of the server environment 701 preferably comprises the main logic circuitry and preferably, as shown, provides all necessary circuitry to interconnect all server environment 701 components. Upon reading the teachings of this specification, those with ordinary skill in the art will now understand that, under appropriate circumstances, considering issues such as changes in computer server environment technology, etc., other computer server subassembly and component constructs including elements, such as, for example, highly-integrated motherboards, blade-computer housings yet to be developed, etc., may suffice.

Preferably the power supply 896 of the server environment 701 comprises a redundant arrangement of individual power supplies that together preferably provide a fail-safe means of providing necessary power for all hardware environment components, as shown. Preferably the power supply 896 minimally comprises at least one power supply of sufficient capacity to operate the essential hardware environment components.

Preferably the storage 890 of the server environment 701 is configured as a Redundant Array of Independent Drives (RAID) preferably having mirroring (copying of data to more than one physical disk); preferably having striping (splitting of data across more than one physical disk), and preferably error correction or preferably fault tolerance (redundant storing of data that allows detecting and fixing of data-integrity anomalies). Preferably the memory 888 of the server environment 701 includes dynamic RAM (random access memory), preferably semiconductor chips that store system software, programs, and data currently used, as shown, by CPU (central processor unit) 886. The memory 888 comprises volatile memory, that is, memory contents of which may be lost when/if server environment 703 loses power. Thus, contents of memory 888 preferably must be stored in the storage 890 prior to powering down the server environment 703.

Preferably the CPU (central processing unit) 886 of the server environment 701 interprets and executes actual computing tasks of the server environment 703 and preferably has capacity for simultaneously executing multiple processing threads (parallel processing). Upon reading the teachings of his specification, those with ordinary skill in the art will now understand that, under appropriate circumstances, considering issues such as changes in semiconductor processing technology, semiconductor processor packaging technology, etc., other semiconductor processing and related packaging constructs including elements, such as, for example, miniaturized chip design, enhanced clocking, enhanced arrangements for thermal control at faster clock-speeds yet to be developed, etc., may suffice.

The removable storage media 882 preferably establishes at least one backup (preferably duplicate copies of system data) preferably on archival media that preferably may be stored on at least one other storage device and preferably retrieved for later use by the system supplier 502. Upon reading the teachings of this specification, those with ordinary skill in the art will now understand that, under appropriate circumstances, considering issues such as changes in long-term electronic data storage and data transfer technology, etc., other long-term electronic data storage means including devices, such as, for example, Internet connected disk-arrays, dynamic storage devices, and static storage devices yet to be developed, etc., may suffice. Both the mouse 880 and the key-board 875 of the preferred server environment 701 preferably comprise standards-based interfaces preferably compatible with input/output port 898, as shown, and are preferably capable of conveying signals to the CPU 886 via their respective interfaces, as shown. Preferably both the mouse 880 and the keyboard 875 allow users to enter commands to direct system executions within the preferred server environment 701.

Preferably the network interface 868 enables the preferred server environment 701 to send at least one communication signal and to receive at least one communication signal from the network 860, preferably using at least one standards-based communication-protocol. Preferably the firewall 855, as shown, isolates the network from the Internet 175, preferably permitting only specific traffic to pass into or out of the server system. Preferably the firewall 855 selectively blocks data traffic, and preferably has state knowledge of all data connectivity sessions passing through the firewall 855. Preferably the firewall 855 minimally has: IEEE 802.1x-based edge authentication, switch access password protection, at least one user-definable setting for enabling or disabling Web, SSH, Telnet, SSL management access, at least one port-based MAC address alert and lock-down, IP address filtering for management access Layer 2/3/4-based Access Control Lists (ACLs), RADIUS and TACACS+ remote authentication, and SSL/SSH encryption. Upon reading the teachings of this specification, those with ordinary skill in the art will now understand that, under appropriate circumstances, considering issues such as changes in data-encryption technology, firewalling technology etc., other data-encryption algorithms and data-network firewalling constructs including elements, such as, for example, multi-layer intrusion detection/prevention, hashing algorithms, and intrusion reporting means yet to be developed, etc., may suffice.

The preferred wireless network access 865 preferably enables the networked user equipment environment 602 to send at least one communication signal preferably to at least one other network-enabled device, preferably using at least one standards-based communication protocol.

The preferred Internet connection 860 of the networked-user-equipment environment 602 preferably has sufficient bandwidth and latency characteristics (data connectivity) such that the system may properly execute all functions with all user devices preferably comprising: the WAP enabled mobile phone 862, the browser enabled point of sale machine 906, the personal digital assistant (PDA) 864, the tablet PC 866, etc. The preferred Internet connection 850 comprises preferably a minimum of one-megabit bandwidth (bi-directional) preferably with latency of less than 100 milliseconds. Upon reading the teachings of this specification, those with ordinary skill in the art will now understand that, under appropriate circumstances, considering issues such as changes in networked-user-equipment technology, miniaturized human-machine interact technology, etc., other networked-user-equipment including human-machine interfaces, such as, for example, integrated networks allowing for multi-media store and forward, and real-time communications via touch-sensitive input/output interfaces, biometrics yet to be developed, etc., may suffice.

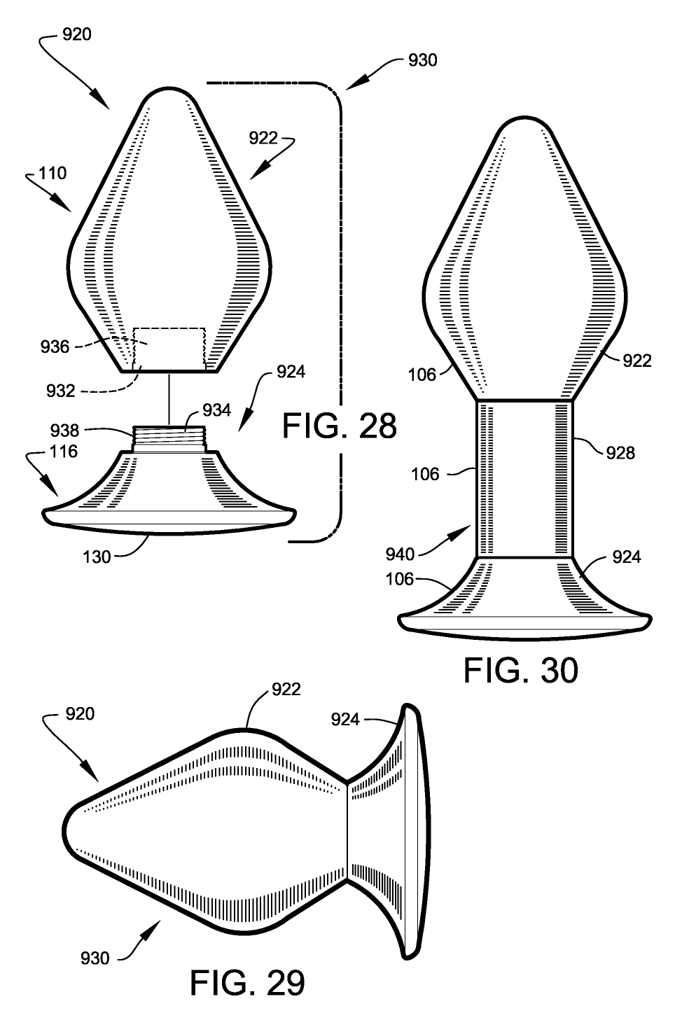

FIG. 28 shows an exploded perspective view, illustrating another sexual aid tool 920 of the stress relief system 100, according to another preferred embodiment of the present invention. FIG. 29 shows a side view, illustrating an assembled sexual aid tool 920 of the stress relief system 100, according to the preferred embodiment of FIG. 28.

Preferably, sexual aid tool 920 comprises a two-piece sexual aid, as shown. Preferably, sexual aid tool 920 is comprised from a selection of a plurality of segmented portions 106, such as those shown in FIG. 1, each segmented portions 106 of such plurality structured and arranged to couple to all other such segmented portions 106. Preferably, any two of the plurality of segmented portions 106, when assembled, comprise sexual-aid tool 920, as shown. FIG. 28 and FIG. 29 illustrate preferred segmented portions used as a sexual aid for insertion into the rectum area through the anus, preferably comprising a first bulbous portion 922 and a second grippable portion 924, as shown. First bulbous portion 922 and second grippable portion 924 are preferably used in combination to assist insertion into the rectum with the second grippable portion 924 sized to prevent loss of the device within the rectum as well as assist removal of the device.

FIG. 30 shows a perspective view, illustrating another assembled sexual aid tool 940 of the stress relief system, according to another preferred embodiment of the present invention. As shown in FIG. 30, segmented sexual aid tool 920 is preferably capable of being assembled and disassembled so that a user may change the shape or size of the sexual aid tool 920 by selecting from available segments (whether sold separately or as a kit as described above herein) such as the lengthening segment 928 shown inserted between first bulbous portion 922 and a second grippable portion 924. Preferably, such selection is user-customizable simply by reattaching a selected segmented portion 106 in a different orientation or by the addition or deletion of additional segmented portions 106 by the user. For example, choosing different segmented portions 106 may increase or decrease the width, increase or decrease the girth, add a segment with a different exterior surface, add a unique protrusion, etc.

The first bulbous portion 922 preferably is selectable from a plurality of first-end portions 110, as shown previously in FIG. 1. Second grippable portion 924 is preferably selectable from a plurality of second-end portions 116, as shown previously in FIG. 1.

As described above and further embodied as a two-piece assembly 930, first-end portions 110 preferably comprise multiple shapes, such as conical shape 122, bulbous shape 124, mushroom shape 126, and helmet shape 128, as shown. While the shapes of first-end portions 110 may also be utilized as second-end portion shapes, second-end portions 116 preferably comprise at least one portion having at least one base element, preferably a flat bottom 130 to allow the segmented sexual aid tool 104 to be placed in an upright position when placed on a flat surface.

First end portions 110 are preferably about two and one-half inches in length, not including external coupling elements, and preferably have a girth preferably between about one inch and about two inches in diameter. Upon reading this specification, those with ordinary skill in the art will now appreciate that, under appropriate circumstances, considering such issues as design preference, user preferences, marketing preferences, cost, structural requirements, available materials, technological advances, etc., other dimensions for girth such as, for example, about one inch to about four inches, larger or smaller dimensions, serpentine dimensions, varying diameters, etc., may suffice.

Preferably, second end portions 116 comprise at least one set of shapes that are aesthetically pleasing and functional (i.e. as a sexual aid, including comprising gripping portions) when matched to at least one of such first end portions 110, as shown. Second end portions 116 are preferably about two and one-half inches in length not including external coupling elements and have a girth at least about an inch in diameter and preferably between about one inch and about two inches in diameter. Upon reading this specification, those with ordinary skill in the art will now appreciate that, under appropriate circumstances, considering such issues as design preference, user preferences, marketing preferences, cost, structural requirements, available materials, technological advances, etc., other dimensions for girth such as, for example, about one inch to about four inches, larger or smaller dimensions, serpentine dimensions, varying diameters, etc., may suffice. The flat bottom 130 preferably has the same diameter as the rest of the second end portion 116 or larger.

Preferably, first bulbous portion 922 and a second grippable portion 924 comprise at least one first coupler element 932 and at least one second coupler element 934 arranged so that the first coupler element 932 is couplable to the second coupler element 934, as shown. In the illustrated preferred embodiment, first coupler element 932 and second coupler element 934 preferably comprise male-female threaded portions, as shown. Preferably, first coupler element 932 comprises a female threaded opening 936 and second coupler element 934 comprises a male threaded protrusion 938, as shown. Upon reading this specification, those with ordinary skill in the art will now appreciate that, under appropriate circumstances, considering such issues as design preference, user preferences, marketing preferences, cost, structural requirements, available materials, technological advances, etc., other coupling arrangements such as, for example, opposite male-female arrangements, bayonet couplers, separate coupling apparatus, etc., may suffice.

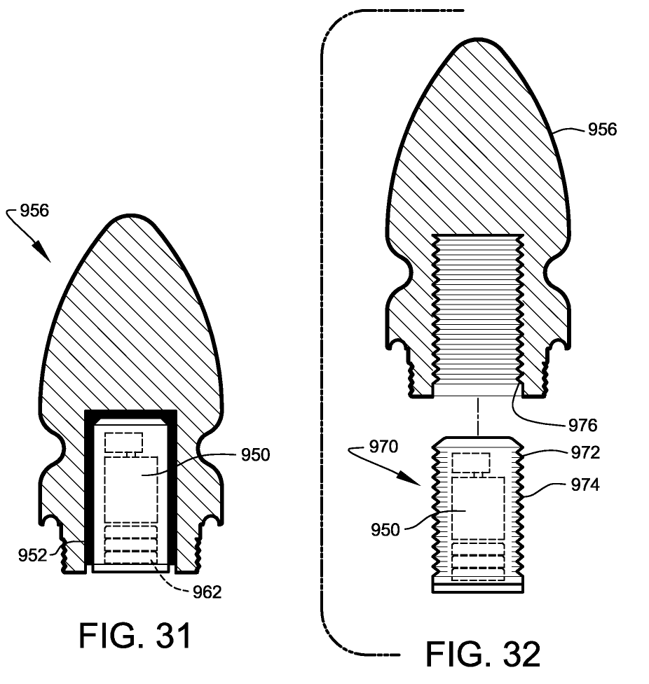

FIG. 31 shows a sectional view illustrating a fixed vibrator unit 950 inserted into the bore portion 952 of segmented portion 956 of a sexual aid tool of the stress relief system 100, according to another preferred embodiment of the present invention.

When preferably assembled into a segmented sexual aid tool, each respective segmented portion 956 preferably comprises at least one bore portion 952, as shown. Upon reading this specification, those with ordinary skill in the art will now appreciate that, under appropriate circumstances, considering such issues as design preference, user preferences, marketing preferences, cost, structural requirements, available materials, technological advances, etc., other internal chamber arrangements such as, for example, multiple hollows, alternating hollows and solid portions, etc., may suffice.

Preferably, a vibrator unit 950 is inserted into bore portion 952, as shown. Vibrator unit 950 is preferably fixed in place, preferably using an adhesive, preferably an epoxy adhesive. Upon reading this specification, those with ordinary skill in the art will now appreciate that, under appropriate circumstances, considering such issues as design preference, user preferences, marketing preferences, cost, structural requirements, available materials, technological advances, etc., other fixing arrangements such as, for example, mechanical attachment, other adhesives, integral manufacture, etc., may suffice.

Preferably, the vibrator unit 950 has replaceable power, preferably replaceable batteries 962, as shown. Upon reading this specification, those with ordinary skill in the art will now appreciate that, under appropriate circumstances, considering such issues as design preference, user preferences, marketing preferences, cost, structural requirements, available materials, technological advances, etc., other power arrangements such as, for example, hard-wired, permanent batteries, rechargeable batteries, etc., may suffice.

The vibrator unit 950 preferably is sized to fit into a standard-sized bore portion 952, previously stated as sized from about ½ inch in diameter to about 1 inch in diameter. Also as previously stated at least a “Slim Line Vibrator” (as manufactured by California Exotics, for example) would suffice, however, smaller vibrator units may be easily manufactured by those knowledgeable in such art and custom-inserted into bore portion 952. Upon reading this specification, those with ordinary skill in the art will now appreciate that, under appropriate circumstances, considering such issues as manufacturing preference, cost, structural requirements, available materials, technological advances, etc., other vibratory devices may suffice.

Bore portion 952 preferably provides for user-preferred addition of elements or devices to customize such segmented portion 956. Preferably, a user may purchase or add such elements or devices, such as, for example, cold or heated water, cold or heated elements, alternate vibratory elements, beads, lubricants, scented liquids, etc. Upon reading this specification, those with ordinary skill in the art will now appreciate that, under appropriate circumstances, considering such issues as manufacturing preference, cost, structural requirements, available materials, technological advances, etc., other elements or devices may suffice.

FIG. 32 shows a sectional view illustrating an insertable vibrator segment 970 for a section of a sexual aid tool of the stress relief system 100, according to another preferred embodiment of the present invention.

Preferably, vibrator unit 950 is positioned in an insertable vibrator segment 970, in a coupling element 972 preferably comprising external male threaded coupler elements 974 that co-operatively engage with female threaded coupler elements 976, is insertable and couplable within such a segmented portion 956, (alternately preferably any such segmented portion) to provide an arrangement wherein a vibrator function is available to be added to such sexual aid tool, as shown. Preferably, as stated in FIG. 31 above, vibrator unit 950 has replaceable power, preferably replaceable batteries 962, as shown. Upon reading this specification, those with ordinary skill in the art will now appreciate that, under appropriate circumstances, considering such issues as design preference, user preferences, marketing preferences, cost, structural requirements, available materials, technological advances, etc., other power arrangements such as, for example, hard-wired, permanent batteries, rechargeable batteries, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A sexual aid system comprising:
a) at least three segments, each segment of said at least three segments structured and arranged to couple to all other said segments;
b) wherein any at least two of said at least three segments, when assembled, comprise a sexual-aid tool; and
c) wherein each said segment of said at least three segments comprises
i) at least one first end comprising at least one first coupler; and/or
ii) at least one second end comprising at least one second coupler; and
d) wherein said at least one first coupler element is attachable to said at least one second coupler element.

2) The system according to claim 1 wherein:
a) any said at least three segments, when assembled, comprise at least one sexual-aid tool;
b) wherein said sexual-aid tool comprises a single longitudinal internal chamber;
c) wherein said single longitudinal internal chamber comprises at least one central axis; and
d) wherein portions of said at least one central axis are located within each one of said at least three intercouplable segments.

3) The system according to claim 2 wherein said single longitudinal internal chamber is structured and arranged to hold at least one vibratory element.

4) The system according to claim 1 wherein said at least one sexual-aid tool is structured and arranged to be length customized by a user.

5) The system according to claim 1 wherein said at least three segments comprise:
a) at least one first end segment comprising at least one first coupler;
b) at least one second end segment comprising at least one second coupler; and
c) at least one middle segment comprising at least at least one first coupler and at least one second coupler;
d) wherein said at least one first coupler is attachable to said at least one second coupler.

6) The system according to claim 5 wherein said at least one sexual-aid tool is structured and arranged to be length adjustable, to any user-selected length, using a plurality of said at least one middle segments.

7) The system according to claim 5 wherein each said at least one first coupler and said at least one second coupler are structured and arranged to assist connecting any of at least one first, at least one second, and at least one third segments of said at least three segments.

8) The system according to claim 5 wherein said at least one first coupler and said at least one second coupler comprise threaded couplers.

9) The system according to claim 1 further comprising:
a) at least one sealing assembly structured and arranged to form at least one substantially fluid-resistant seal between intercoupled pairs of said at least three segments;
b) wherein said at least one sealing assembly assist in retaining fluids within said single longitudinal internal chamber.

10) The system according to claim 9 wherein said at least one sealing assembly comprises a plurality of circumferential sealing members with each one structured and arranged to seal such intercoupled pairs of said at least three segments.

11) The system according to claim 10 wherein each one of said plurality of circumferential sealing members comprises at least one O-ring seal.

12) The system according to claim 1 wherein at least one of said at least three segments comprises at least one millable plastic material.

13) The system according to claim 12 wherein said at least one millable plastic material substantially comprises acrylic.

14) The system according to claim 1 wherein at least one of said at least three segments comprises at least one metal.

15) The system according to claim 4 wherein said at least one sexual-aid tool substantially comprises at least one metal.

16) The system according to claim 15 wherein said at least one metal substantially comprises aluminum.

17) The system according to claim 16 wherein said aluminum comprises at least one anodized finish.

18) The system according to claim 1 wherein at least one of said at least three segments comprises at least one axially symmetric outer shape.

19) The system according to claim 5 wherein at least one of said at least three segments comprises at least one axially asymmetric outer shape.

20) The system according to claim 1 wherein said at least one sexual-aid tool comprises at least one generally phallic shape.

21) A sexual aid kit system for producing user-assembled segmented sexual aid tools, such method comprising:
a) at least one starter sexual aid kit comprising
b) at least three intercouplable segments,
c) at least one set of instructions for assembling said at least three intercouplable segments to form at least one sexual-aid tool, and
d) at least one package structured and arranged to hold said at least three intercouplable segments;
e) wherein such assembled sexual-aid tool comprises a single longitudinal internal chamber;
f) wherein such single longitudinal internal chamber comprises at least one central axis; and
g) wherein portions of such at least one central axis are located within each one of said at least three intercouplable segments.

22) The sexual aid kit system according to claim 21 further comprising:
a) at least one accessory sexual aid kit;
b) wherein said at least one accessory sexual aid kit comprises at least one member of the group consisting essentially of
c) at least one additional intercouplable segment intercouplable with at least one of said at least three intercouplable segments of said at least one starter sexual aid kit,
d) at least one sexual aid element insertable within said single longitudinal internal chamber
e) at least one storage pouch structured and arranged to store such sexual-aid tool,
f) at least one repair item structured and arranged to assist user repair of such sexual-aid tool,
g) at least one set of instructions, and
h) at least one package structured and arranged to hold the contents of said at least one accessory sexual aid kit.

23) The sexual aid kit system according to claim 21 further comprising at least one additional individually packaged intercouplable segment intercouplable with at least one of said at least three intercouplable segments of said at least one starter sexual aid kit.

24) A method, relating to the production of segmented sexual aid tools comprising a plurality of intercouplable segments, such method comprising the steps of:
a) producing at least one computer-aided design for at least one segmented sexual aid tool comprising a plurality of intercouplable segments;
b) deriving from such at least one computer-aided design, software control instructions for at least one multi-axis computer numerical controlled machine tool;
c) producing at least one first end segment of such segmented sexual aid tool using at least one multi-axis computer numerical controlled machine tool controlled by such software control instructions;
d) producing at least one second end segment of such segmented sexual aid tool using such at least one multi-axis computer numerical controlled machine tool controlled by such software control instructions; and
e) producing at least one intermediate segment of such segmented sexual aid tool using such at least one multi-axis computer numerical controlled machine tool controlled by such software control instructions;
f) wherein such at least one first end segment comprises at least one first coupler;
g) wherein such at least one second end segment comprises at least at least one second coupler;
h) wherein such at least one intermediate segment comprises both at least one first coupler and at least one second coupler; and
i) wherein such at least one first coupler is intercouplable with such at least one second coupler.

25) The method according to claim 24 further comprising the step of providing such at least one substantially solid material in the form of at least one aluminum billet.

26) The method according to claim 24 further comprising the step of polishing at least one of such at least one first end segment, such at least one second end segment, and such at least one intermediate segment.

27) The method according to claim 24 further comprising the step of applying at least one anodized finish to at least one of such at least one first end segment, such at least one second end segment, and such at least one intermediate segment.

28) A method, relating to marketing of segmented sexual aid tools comprising at least one assembly of user-interchangeable sexual-aid-tool parts, such method comprising the steps of:
a) displaying in at least one first display, such segmented sexual aid tools in a substantially assembled condition;
b) displaying in at least one second display, a plurality of such user-interchangeable sexual-aid-tool parts; and
c) displaying in at least one third display, adjoining such at least one first display and such at least one second display, information relating to possible user-customization of such segmented sexual aid tools using such intercouplable sexual aid tool parts.

29) The method according to claim 28 further comprising the steps of:
a) offering for sale such segmented sexual aid tools and such plurality of user-interchangeable sexual-aid-tool parts;
b) wherein such step of offering for sale comprises the step of displaying within at least one of such at least one first display, such at least one second display, and such at least one third display, product ordering information for assisting selection and ordering of such segmented sexual aid tools and such plurality of user-interchangeable sexual-aid-tool parts.

30) The method according to claim 29 wherein such product ordering information comprises at least one telephone number of at least one segmented sexual aid tools product fulfillment site.

31) The method according to claim 29 wherein such product ordering information comprises at least one Internet website address associated with at least one segmented sexual aid tools product fulfillment website.

32) The method according to claim 29 wherein such product ordering information comprises at least one order form usable within at least one segmented sexual aid tools retail site.

33) A method, relating to marketing of segmented sexual aid tools comprising at least one assembly of user-interchangeable sexual-aid-tool parts, such method comprising the steps of:
a) providing to at least one customer, at least one purchasing-interface for the purchasing of such user-interchangeable sexual-aid-tool parts;
b) wherein such at least one purchasing-interface comprises;
c) at least one customer-selection interface structured and arranged to enable selecting of at least one custom combination of such user-interchangeable sexual-aid-tool parts usable to assemble at least one segmented sexual aid tool,
d) at least one customer-order interface structured and arranged assist in generating at least one custom order of such user-interchangeable sexual-aid-tool parts, and
e) at least one customer-payment interface structured and arranged assist in the acceptance of payment at least one custom order of such user-interchangeable sexual-aid-tool parts;
f) providing for the manufacture of such at least one custom order of such user-interchangeable sexual-aid-tool parts on receipt of such at least one custom order and such payment;
g) providing for shipping such at least one custom order of such user-interchangeable sexual-aid-tool parts to such at least one customer.

34) The method according to claim 33 further comprising the step of establishing at least one Internet website server structured and arranged host at least one website comprising such at least one purchasing-interface.

35) The method according to claim 33 further comprising the step of establishing at least one retail distribution site comprising such at least one purchasing-interface.

36) A sexual aid system comprising:
a) at least three segments, each segment of said at least three segments structured and arranged to couple to all other said segments;
b) wherein any at least two of said at least three segments, when assembled, comprise a sexual-aid tool; and
c) wherein each said segment of said at least three segments comprises
i) at least one first end comprising at least one first coupler element; and/or
ii) at least one second end comprising at least one second coupler element; and
d) wherein said at least one first coupler element is attachable to said at least one second coupler element.
